(19) United States
(12) Patent Application Publication
(10) Pub. No.: US 2007/0199895 A1
(43) Pub. Date: Aug. 30, 2007

(54) Method for treating septic tank effluent

(76) Inventor: Charles E. Friesner, Perrysburg, OH (US)

Correspondence Address: PURDUE LAW OFFICES;2735 N. HOLLAND-SYLVANIA ROAD, SUITE B-2, TOLDEO, OH, 43615, US

(21) Appl. No.: 11/592,013

(22) Filed: Nov. 2, 2006

Related U.S. Application Data
(60) Provisional application No. 60/733,088, filed on Nov. 2, 2005.

(51) Int. Cl. C02F 3/00

(52) U.S. Cl. 210/617

(57) ABSTRACT

A method for treating the liquid effluent from a septic tank is disclosed, as is apparatus in which the method can be practiced. The method involves pumping the effluent to the bottom of a treatment vessel packed with pebbles, glass beads or the like to fill the vessel to a predetermined level, and then pumping additional effluent to the bottom to cause a non-turbulent, upward movement of the effluent in the vessel. Treated effluent is withdrawn from the upper portion of the vessel at substantially the rate at which the effluent is pumped to the bottom of the vessel, which is sufficiently low that the treated effluent withdrawn from the upper portion of the vessel is substantially devoid of organic material. The withdrawn effluent is pasteurized. A structure in which a desired joint pattern is achieved by using each of two different blocks in two different relative rotational positions is also disclosed.

### FIELD OF THE INVENTION

This invention is a method for treating septic tank effluent and, more particularly, is such a method in which the effluent is treated to eliminate organic materials and nutrients therefrom before it is discharged to the environment. Preferably, the treated effluent is pasteurized, and the pasteurized material is then discharged to the environment as either a liquid or a vapor which, in either case, is not a health hazard. The invention is also a structure in which the method described above can be practiced, and a house which can contain that structure

### BACKGROUND OF THE INVENTION

On site sewage disposal systems are frequently used in rural and other areas where municipal plants are not available. Typically, waste processed in such a system enters a septic tank in which solids settle to the bottom and, grease and scum float to the top, while liquid effluent flows from a portion of the tank between the solids in the bottom and the scum at the top. The effluent from the tank, which is aqueous, and contains phosphorus compounds, nitrates, organic materials and nutrients, flows through a distribution box, several carefully leveled pipes with holes along their lengths, and through the holes and beds of gravel which surround the pipes to an absorption area where the organic materials and nutrients are consumed by aerobic bacteria and from which relatively pure water flows, mixing with ground water (see http://www.epa.gov/seahome/septics, an EPA website).

Such a sewage disposal system as that described above, if adequately designed and maintained, can effectively remove the organic material and nutrients from the septic tank effluent if the absorption area is sufficiently large. If not, groundwater pollution occurs, and can be a serious problem.

### BRIEF DESCRIPTION OF THE INSTANT INVENTION

The instant invention is a method for treating the liquid effluent from a septic tank which does not require a large absorption area and, therefore, can be used in congested areas where a conventional septic system would cause pollution. The method comprises the steps of pumping the liquid septic tank effluent to the bottom of a treatment vessel in which the effluent is treated by contact with pebbles, glass fibers, sand or the like, and withdrawing treated effluent from the upper portion of the treatment vessel at substantially the rate at which the effluent is pumped to the bottom of the vessel. In a preferred embodiment, the method also includes the step of pasteurizing or the steps of pasteurizing and vaporizing the treated effluent withdrawn from the upper portion of the treatment vessel. In another preferred embodiment, the septic tank effluent is collected in a holding tank from which it is pumped, periodically, to the treatment vessel. Initially, at the beginning of operation, pumping the effluent to the bottom thereof fills the treatment vessel; thereafter pumping additional effluent into the vessel causes a non-turbulent, upward movement of the effluent in the vessel. Preferably, the treated effluent is pasteurized, or pasteurized and vaporized, either while it is still in the treatment vessel or in a separate vessel. The rate at which liquid effluent is pumped to the bottom of the treatment vessel is sufficiently low that the treated effluent which reaches the top of the treatment vessel is substantially devoid of organic materials and nutrients.

It is an object of the invention to provide a method for treating the liquid effluent from a septic tank.

It is another object to provide a method which removes organic materials and nutrients from the septic tank effluent, and purifies the effluent to such an extent that it can safely be discharged to the environment.

It is still another object to provide such a method which includes the additional step of pasteurizing the septic tank effluent from which organic materials and nutrients have been removed.

It is yet another object to provide such a method which includes the additional step of vaporizing the septic tank effluent from which organic materials and nutrients have been removed.

It is still another object to provide apparatus in which such a method can be practiced.

Other objects and advantages will be apparent from the following description of preferred embodiments of the invention, reference being made to the accompanying drawings, in which:

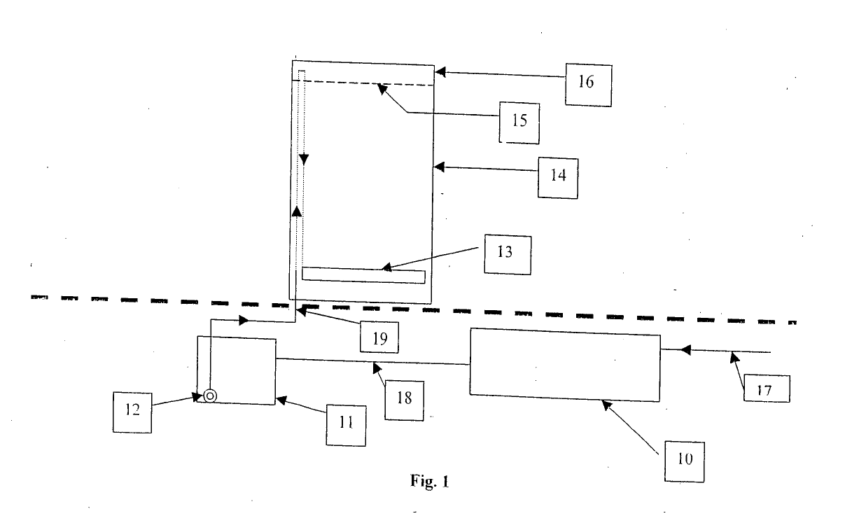

FIG. 1 is a flow diagram identifying the steps in a preferred method of the invention for treating the liquid effluent from a septic tank.

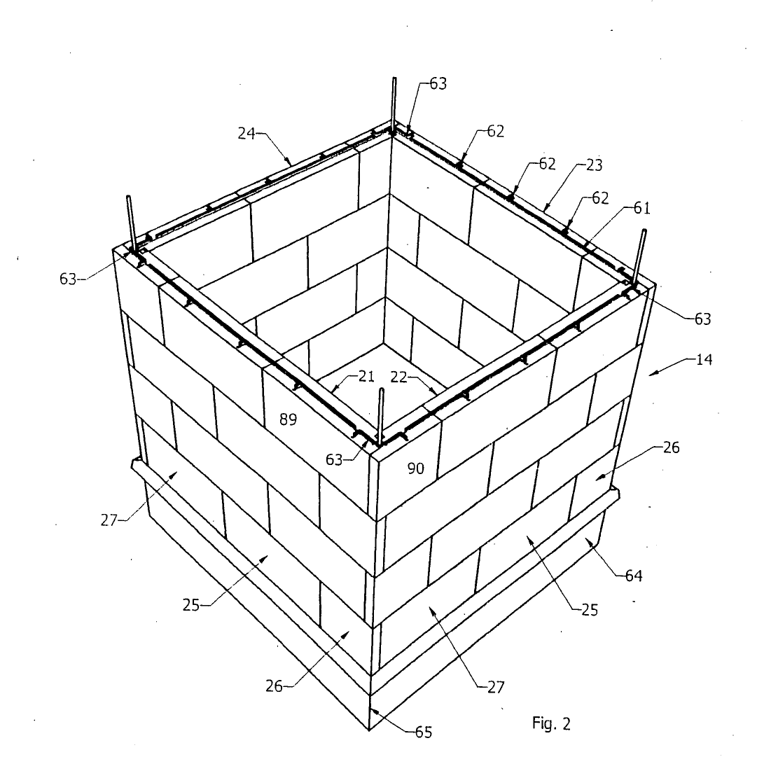

FIG. 2 is a perspective view showing a portion of a wall structure which is one embodiment of the instant invention.

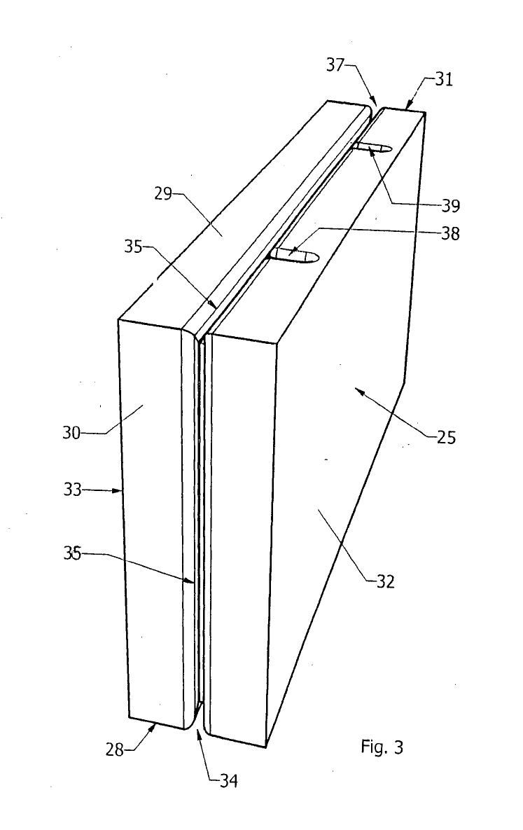

FIG. 3 is a view in perspective showing an end, the top and one side of a block which is a component of the wall structure of FIG. 2.

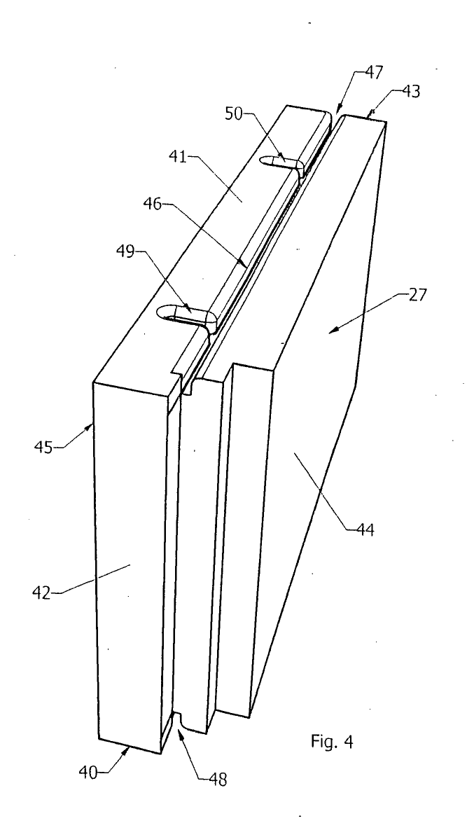

FIG. 4 is a view in perspective showing an end, the top and one side of another block which is a component of the wall structure of FIG. 2.

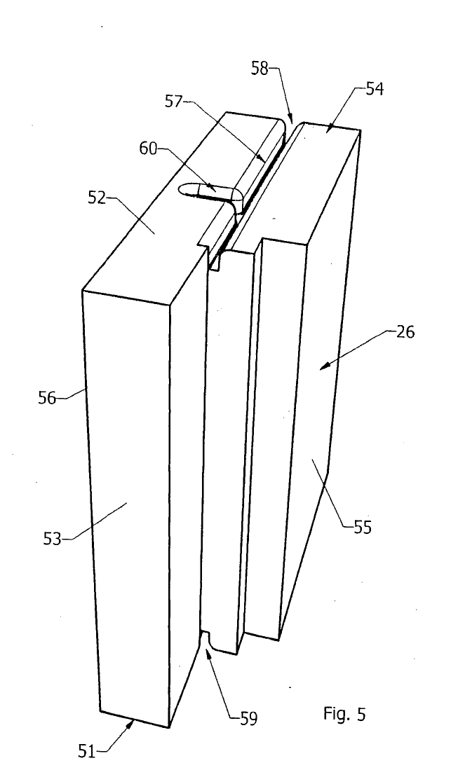

FIG. 5 is a perspective view showing an end, the top and one side of still another block which is a component of the wall structure of FIG. 2.

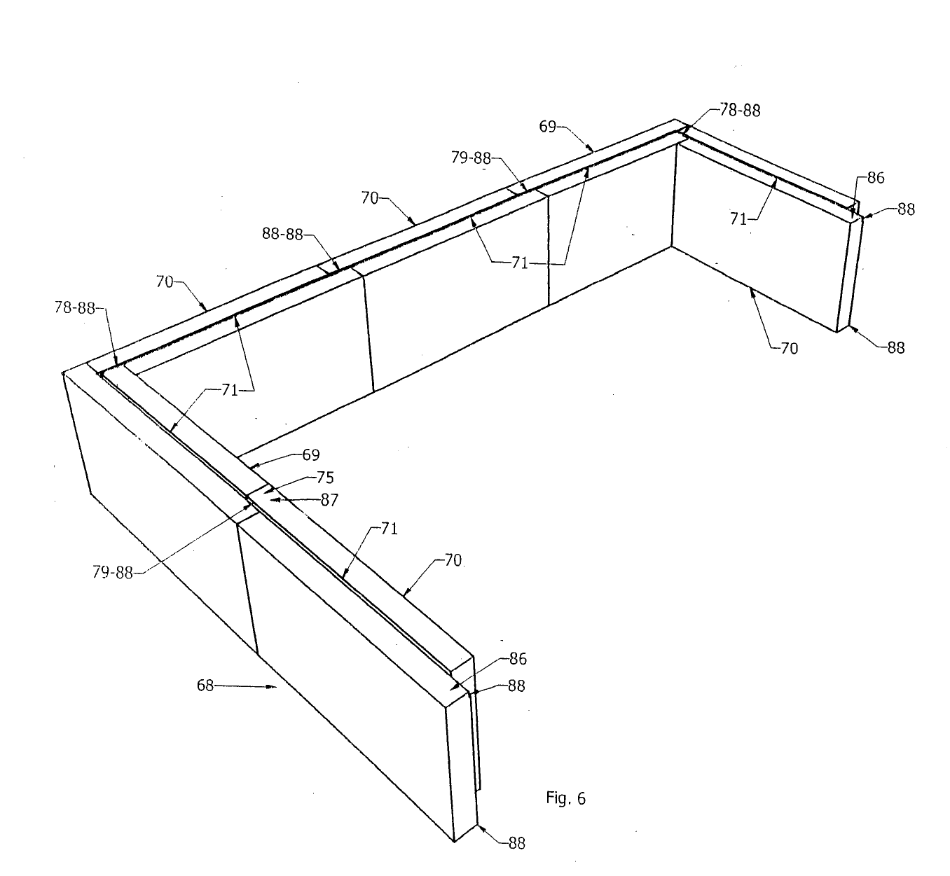

FIG. 6 is a view in perspective of a fragment of another wall structure which is another embodiment of the instant invention.

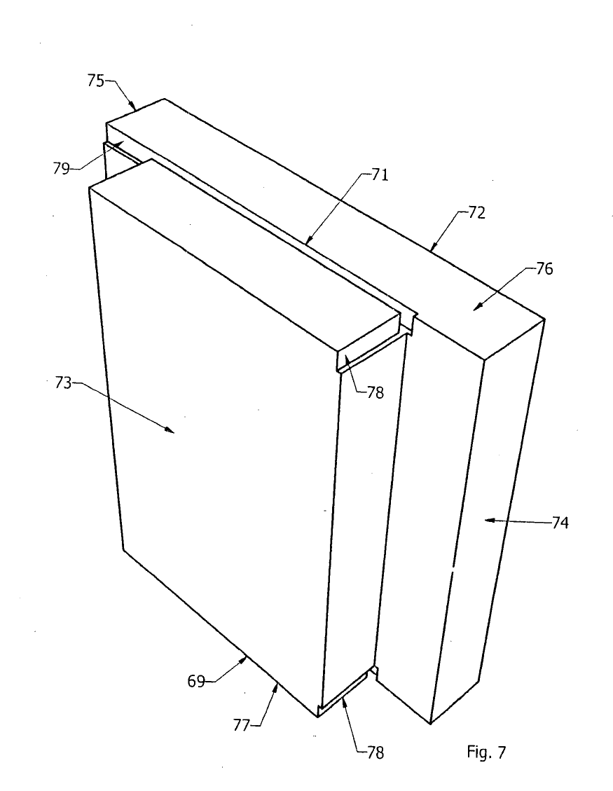

FIG. 7 is a perspective view showing a block which is a component of the fragment of a wall structure shown in FIG. 6.

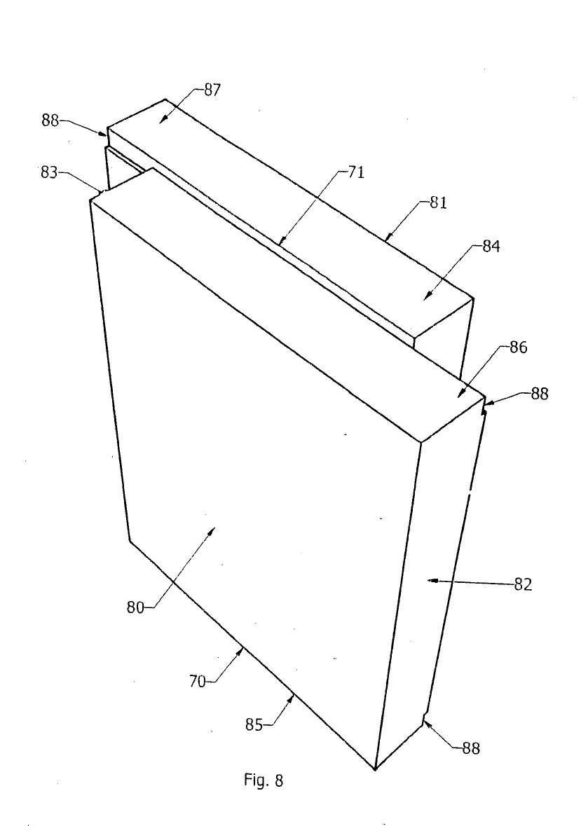

FIG. 8 is a view in perspective showing a block which is a second component of the fragment of a wall structure shown in FIG. 6.

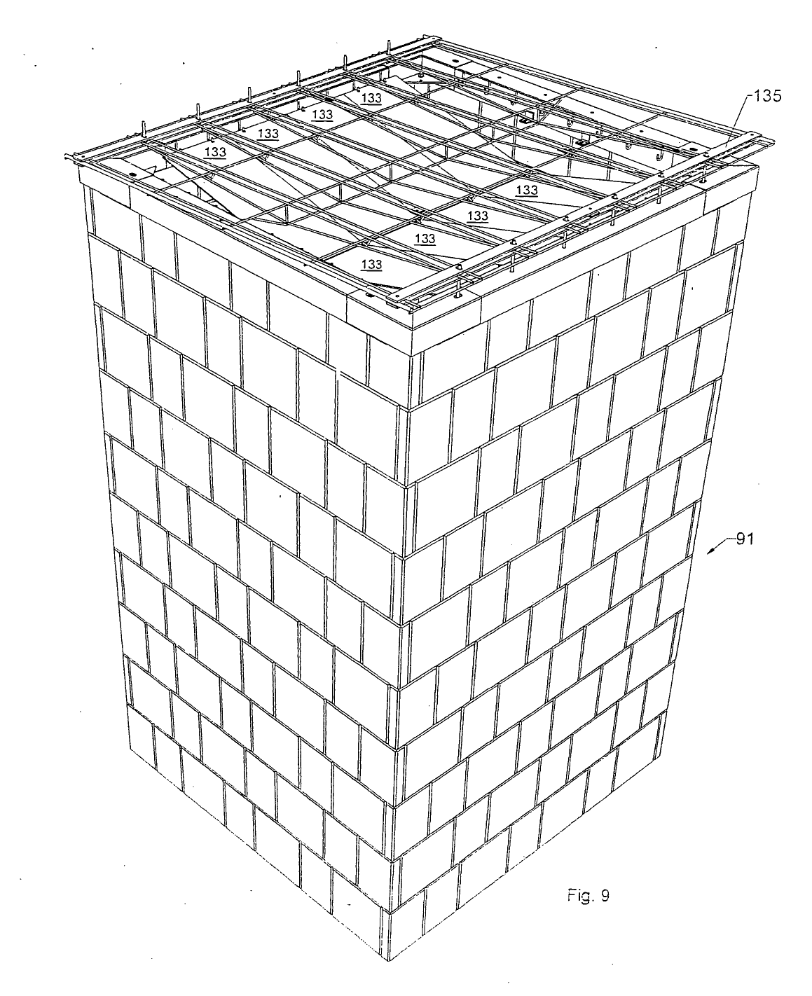

FIG. 9 is a perspective view showing a free-standing structure in which septic tank effluent can be treated according to the invention to eliminate organic materials and nutrients therefrom.

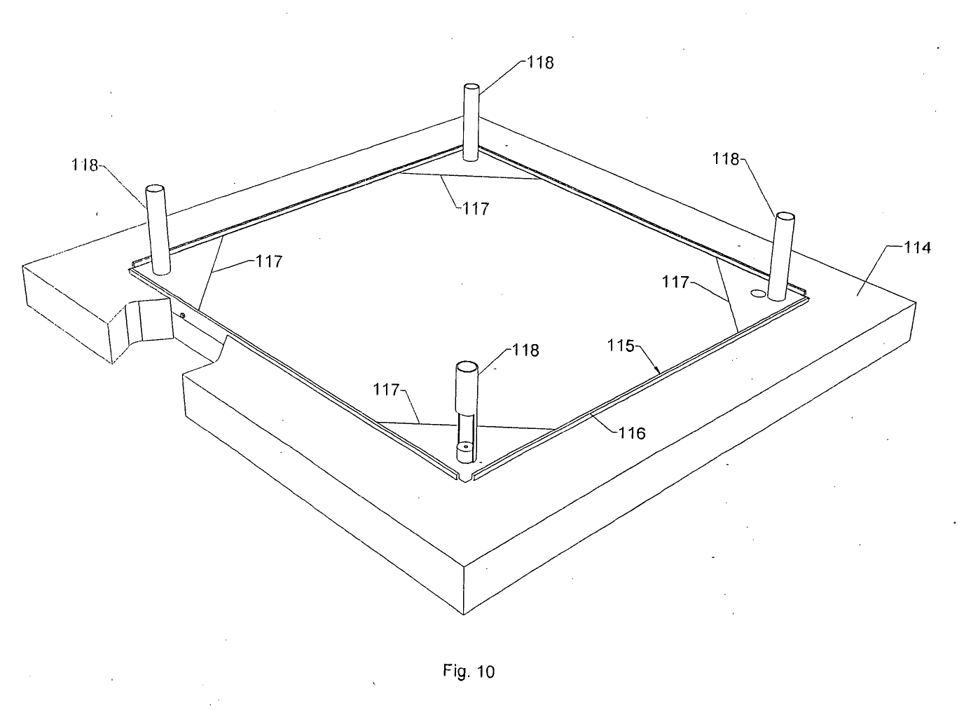

FIG. 10 is a view in perspective showing the foundation of the structure of FIG. 9 and a spline which is attached to the foundation to receive a first course of blocks from which the structure is produced.

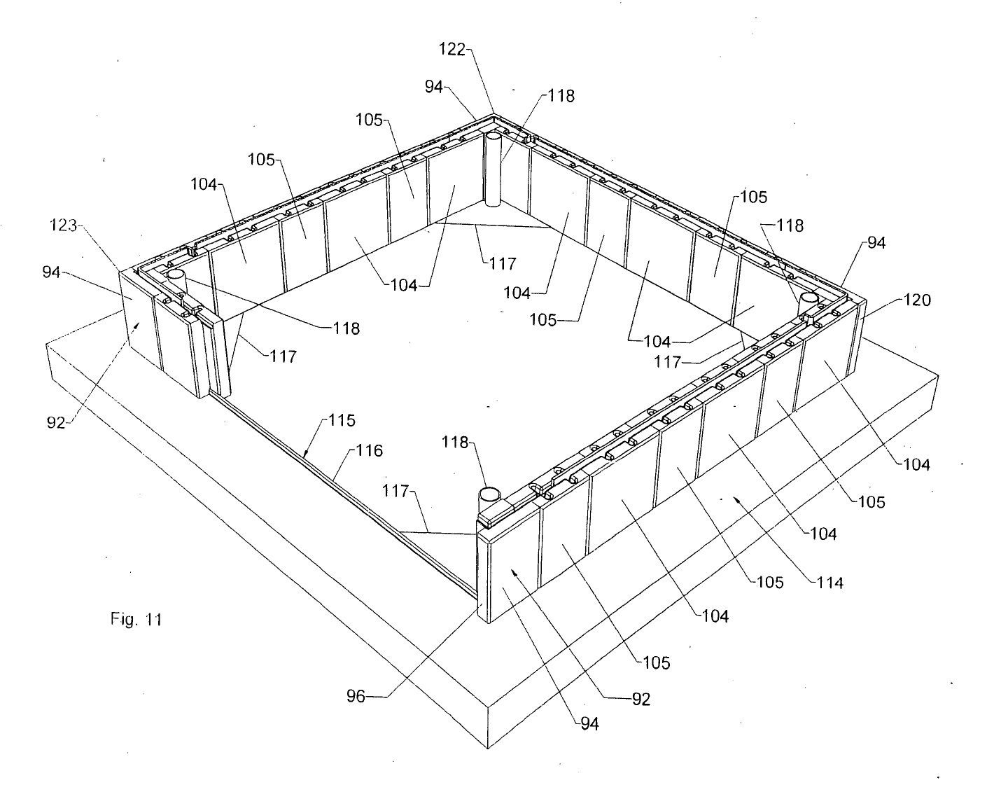

FIG. 11 is a perspective view showing the foundation and spline of FIG. 10 and a first course of blocks on the foundation.

FIG. 12 is a view in perspective showing the first four courses of blocks of the structure of FIG. 9.

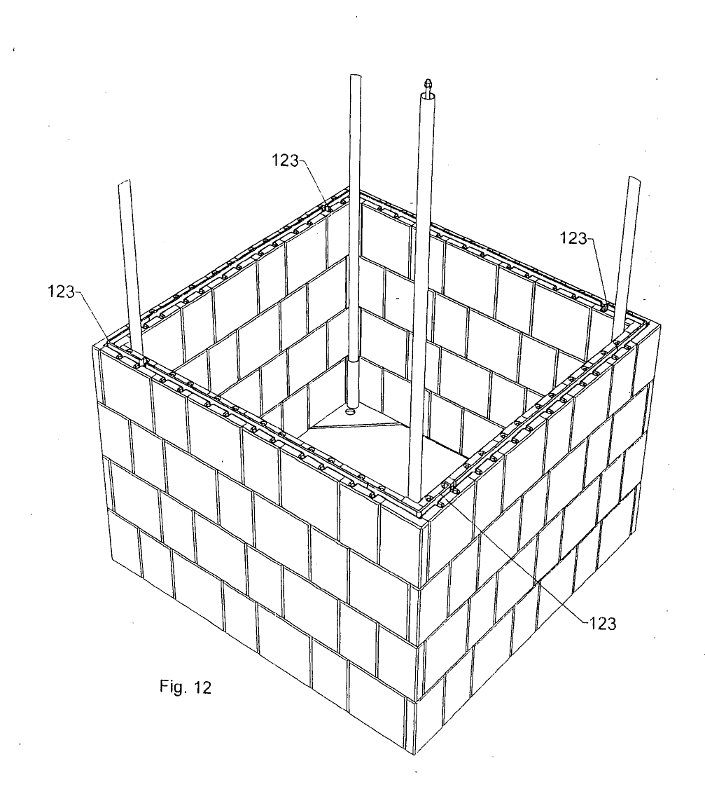

FIG. 13 is a perspective view similar to FIG. 12, but showing the first five courses of blocks of the structure of FIG. 9.

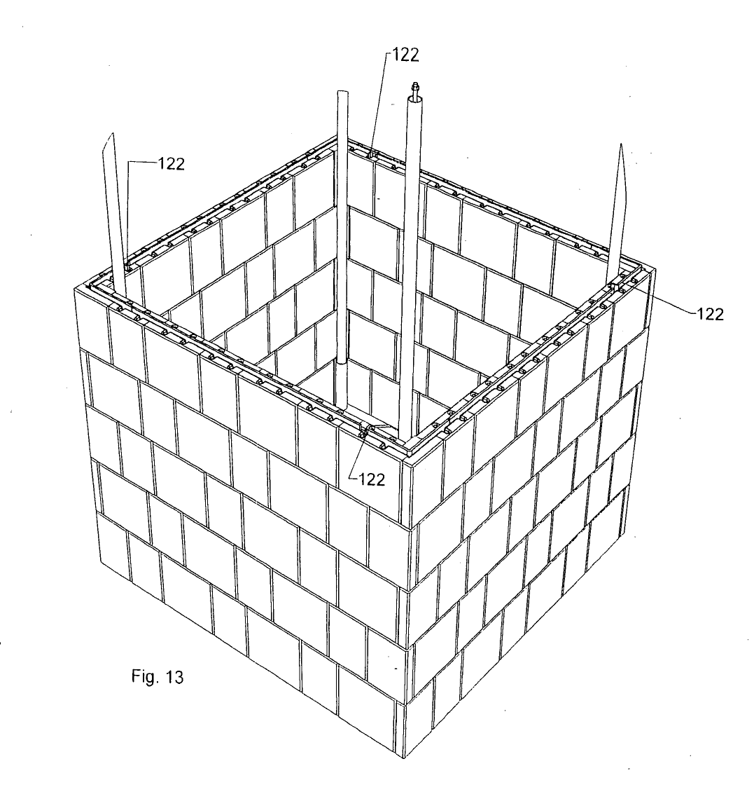

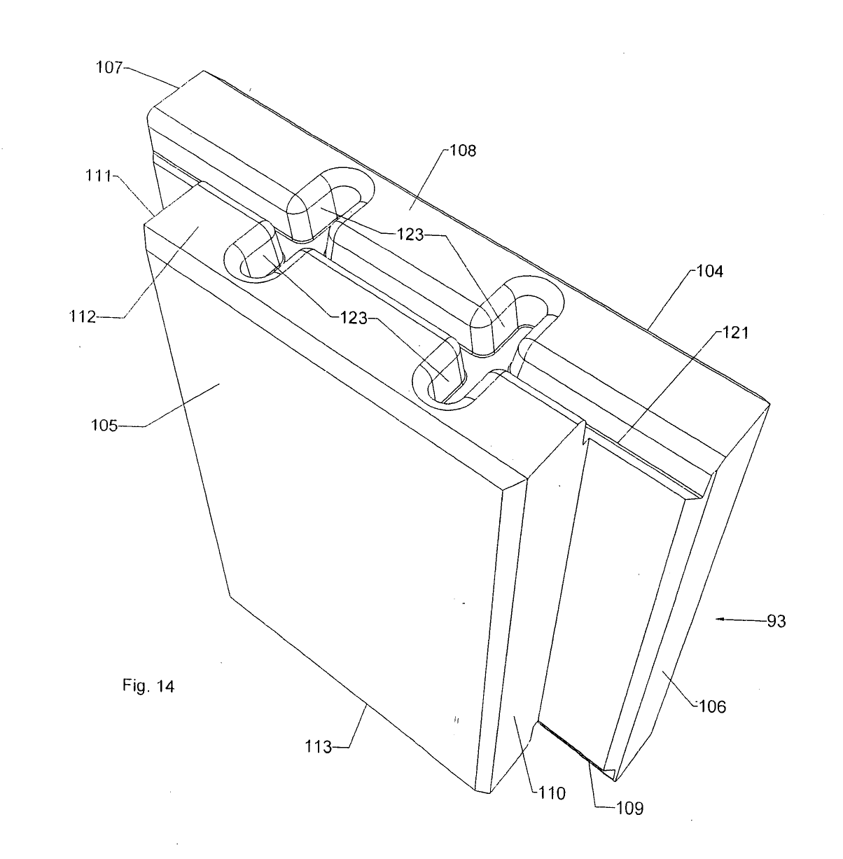

FIG. 14 is a view in perspective of one of two blocks which are used in producing the free standing structure of FIG. 9.

FIG. 15 is a perspective view of the second of two blocks which are used in producing the free standing structure of FIG. 9.

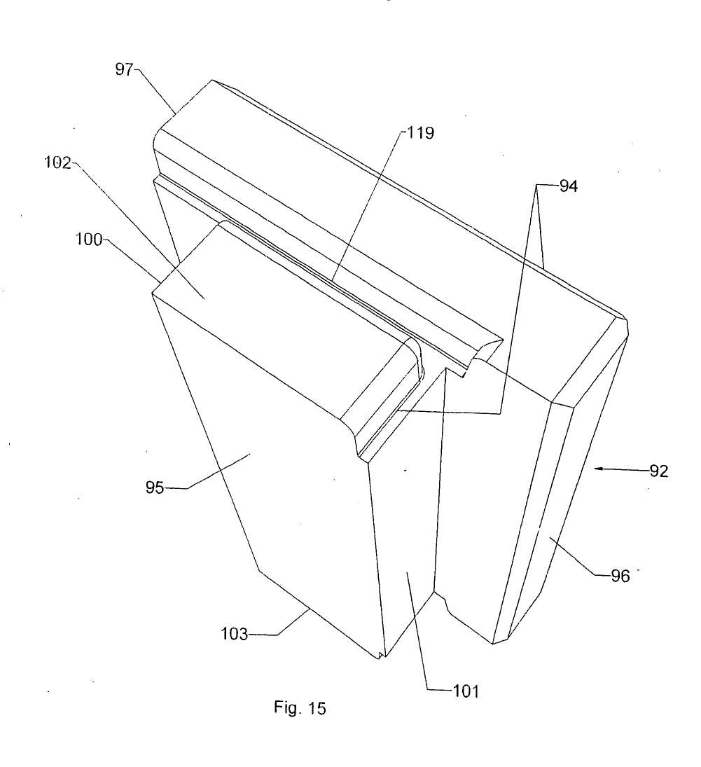

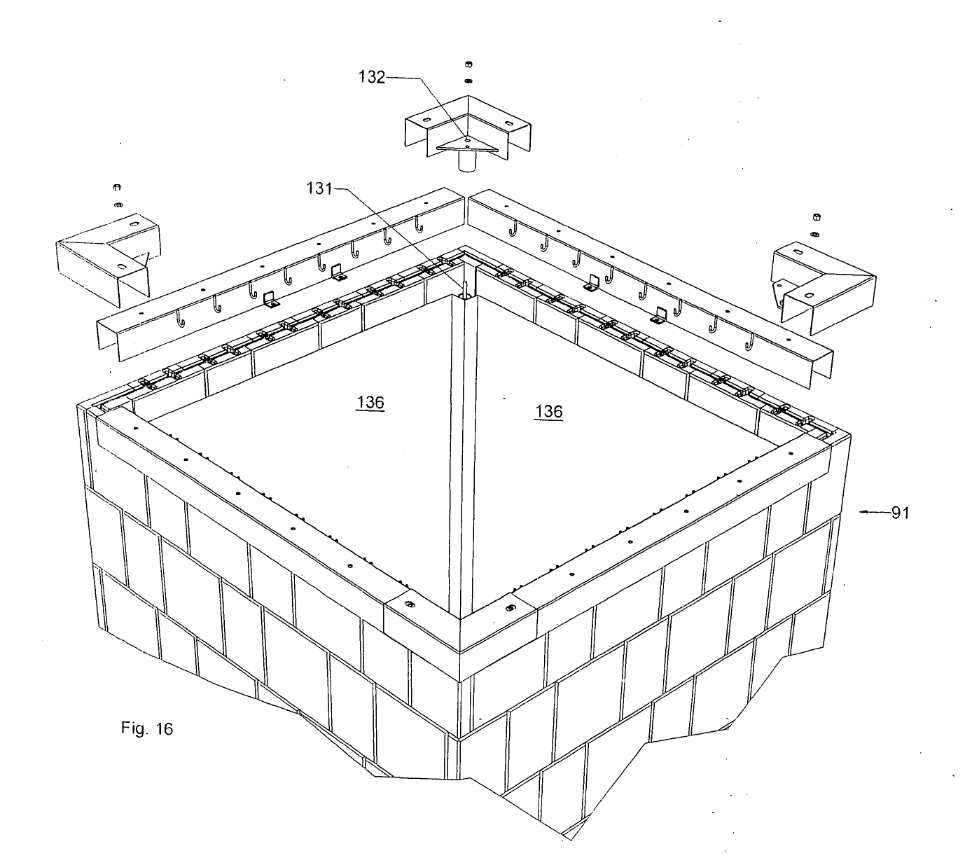

FIG. 16 is a view in perspective similar to FIGS. 12 and 13, but showing all 10 courses of blocks of the structure of FIG. 9 and a cap and illustrating the installation of the cap on the tenth course

FIG. 17 is a perspective view similar to FIG. 16, but with solar receptor panels added.

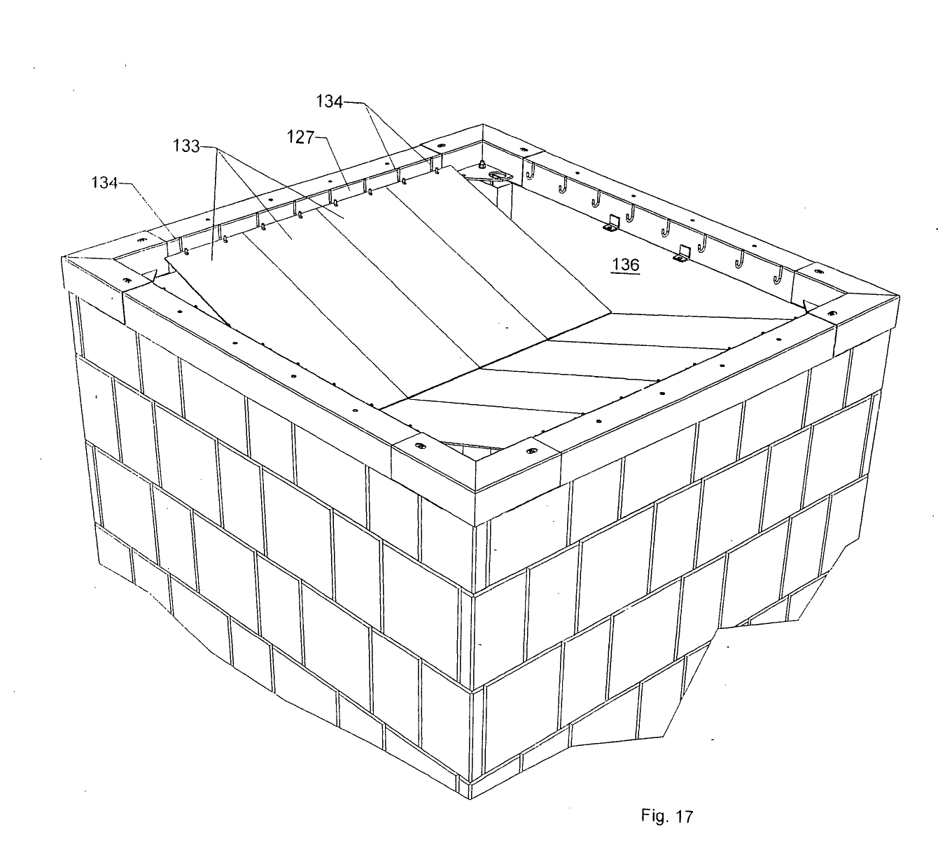

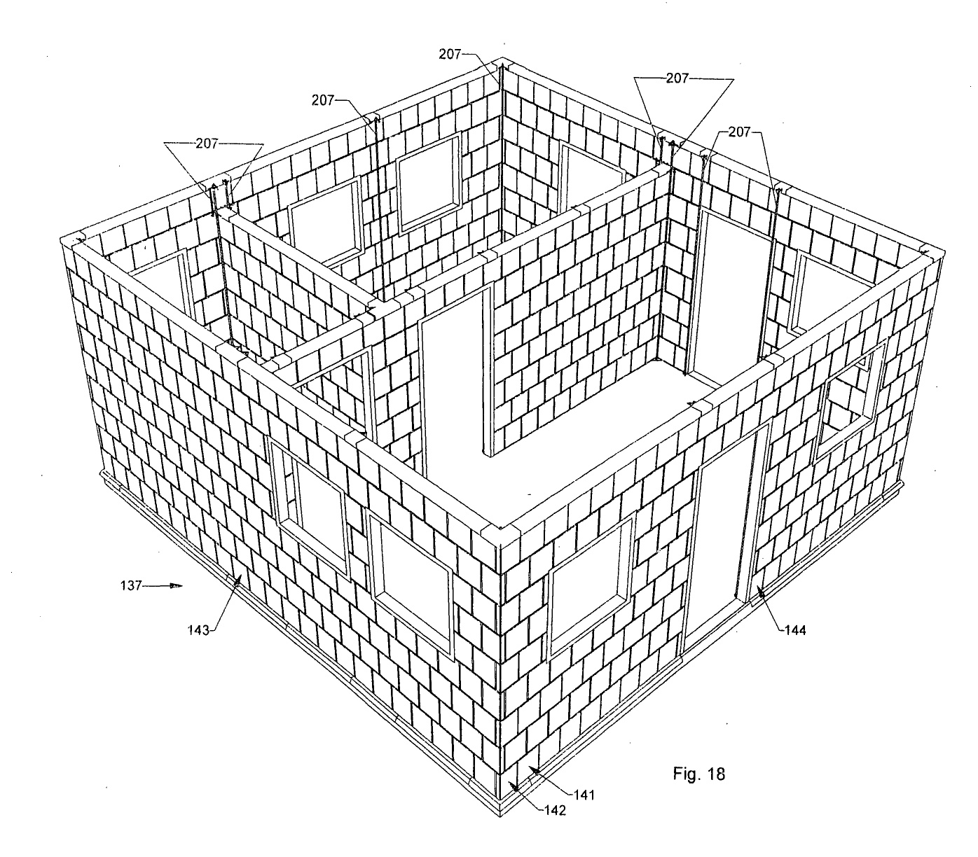

FIG. 18 is a view in perspective showing nine courses of another building structure according to the invention.

FIG. 19 is a perspective view showing a spline which is attached to the foundation of the building structure of FIG. 18.

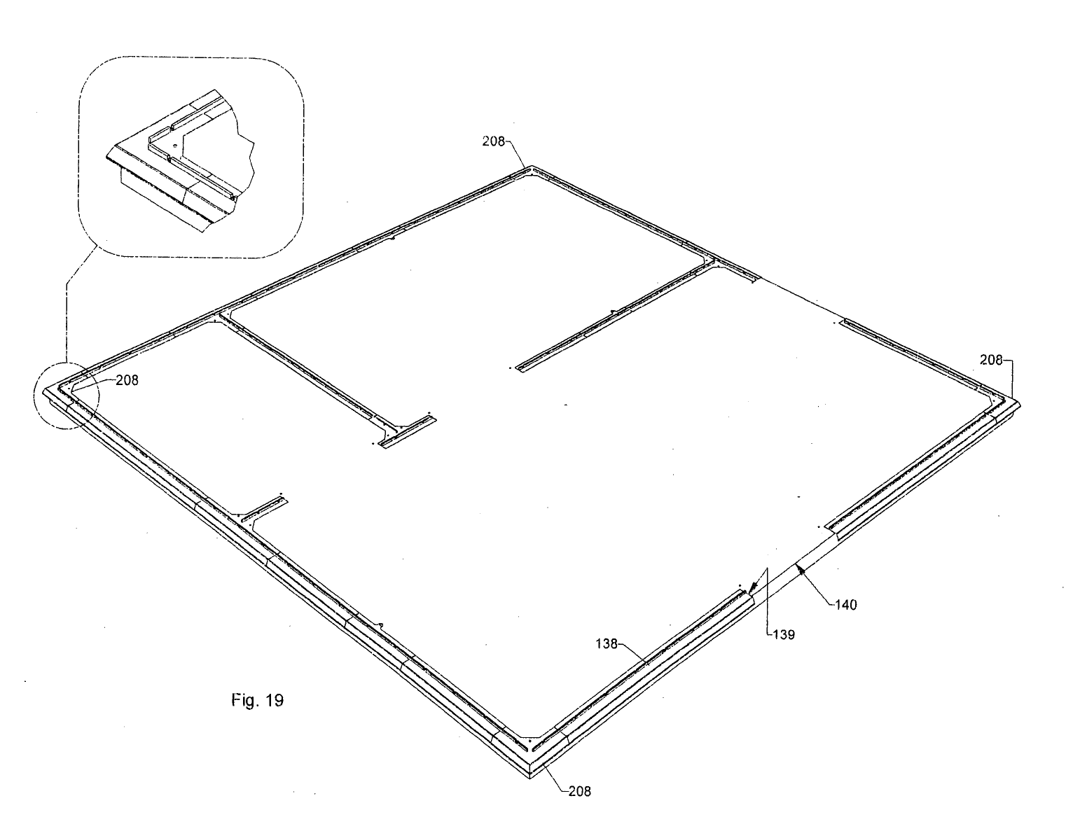

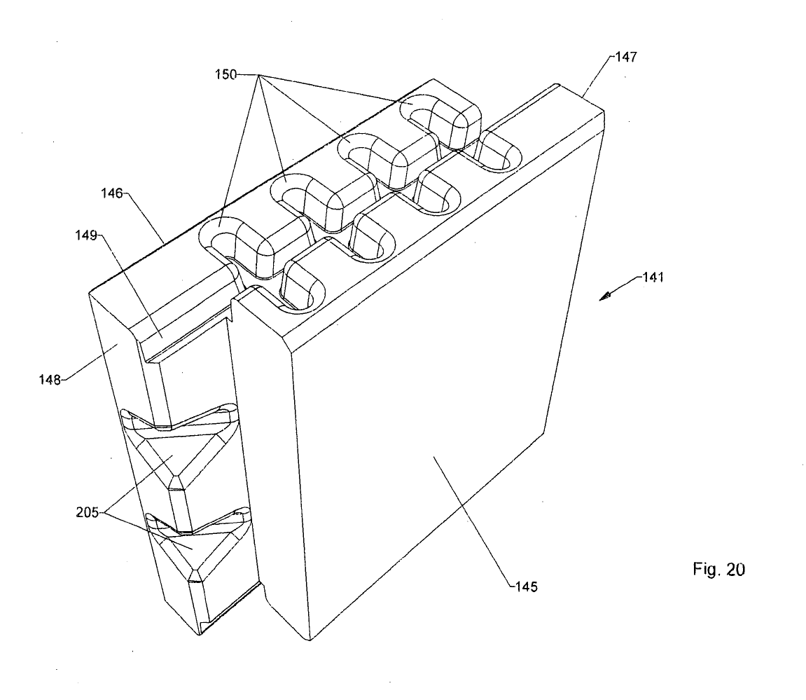

FIGS. 20 and 21 are views in perspective showing blocks which are similar to that shown in FIG. 8, constituting, in essence, variations of that block.

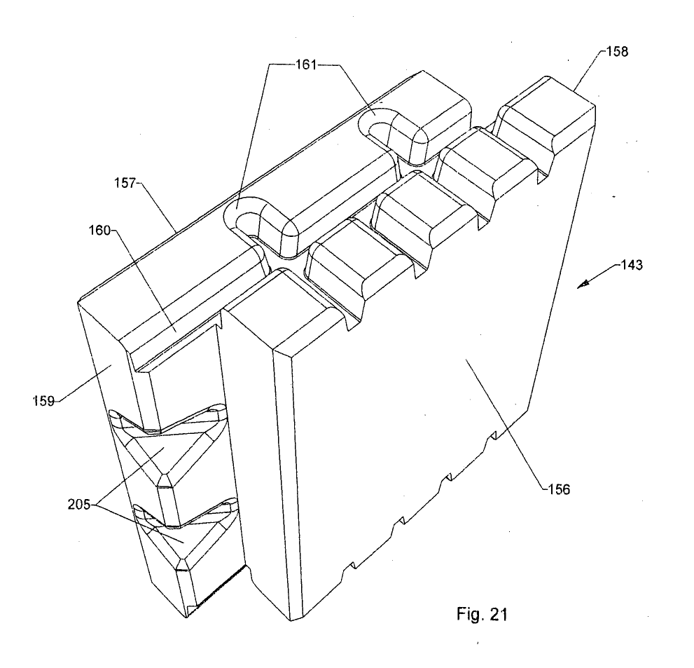

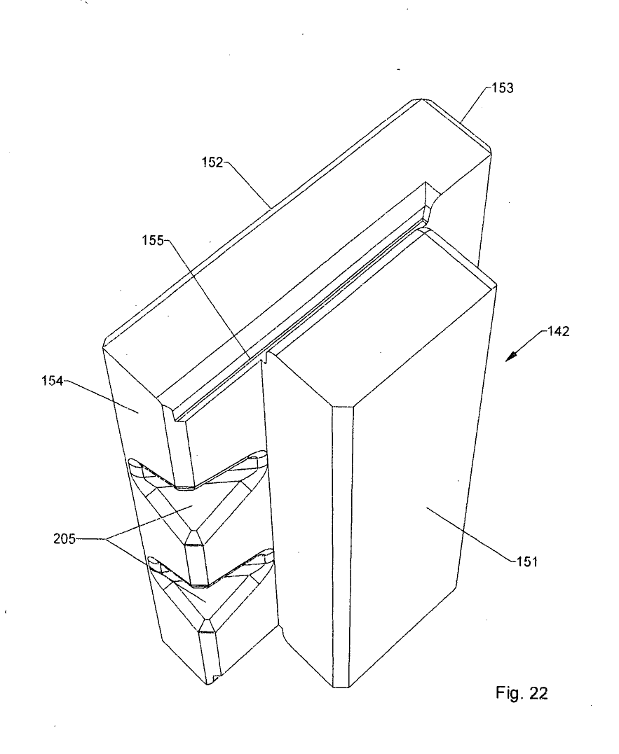

FIG. 22, is a perspective view of a block which is similar to that of FIG. 15, constituting a variation of that block

FIGS. 23 through 26 are views in perspective showing blocks which are similar to the block of FIG. 4, but are used for a different purpose.

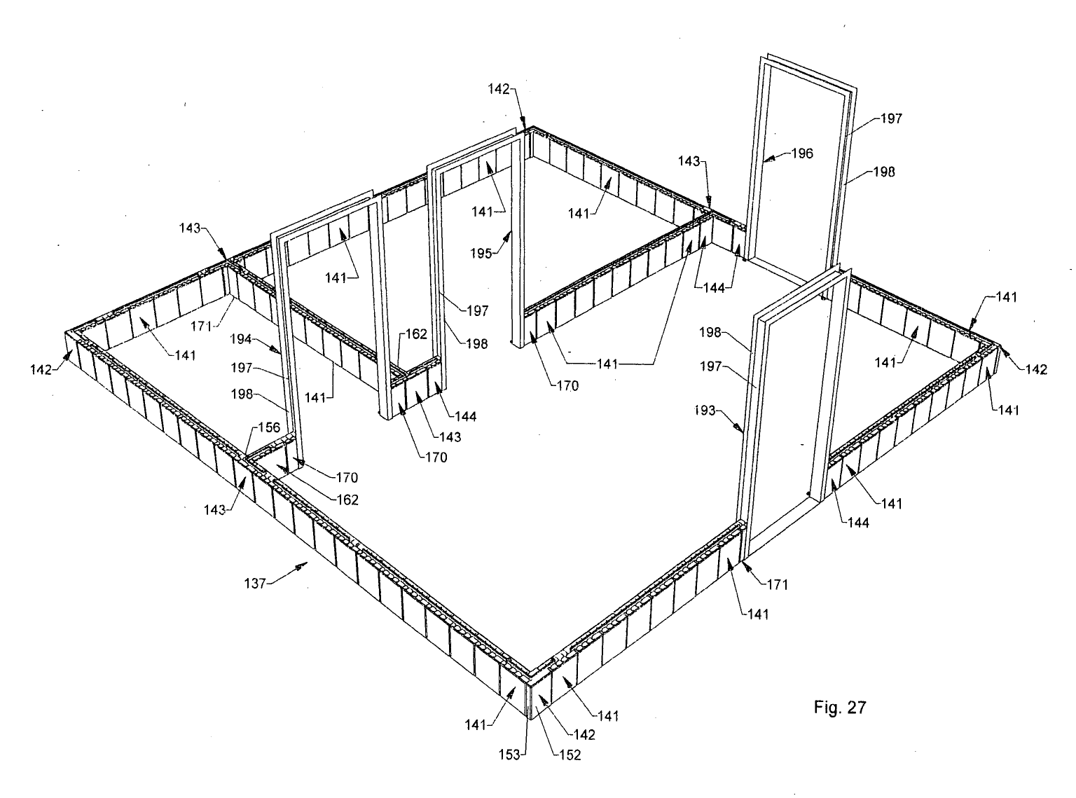

FIG. 27 is a view in perspective showing the first of the nine courses of the building structure of FIG. 18 and four door frames of that building structure.

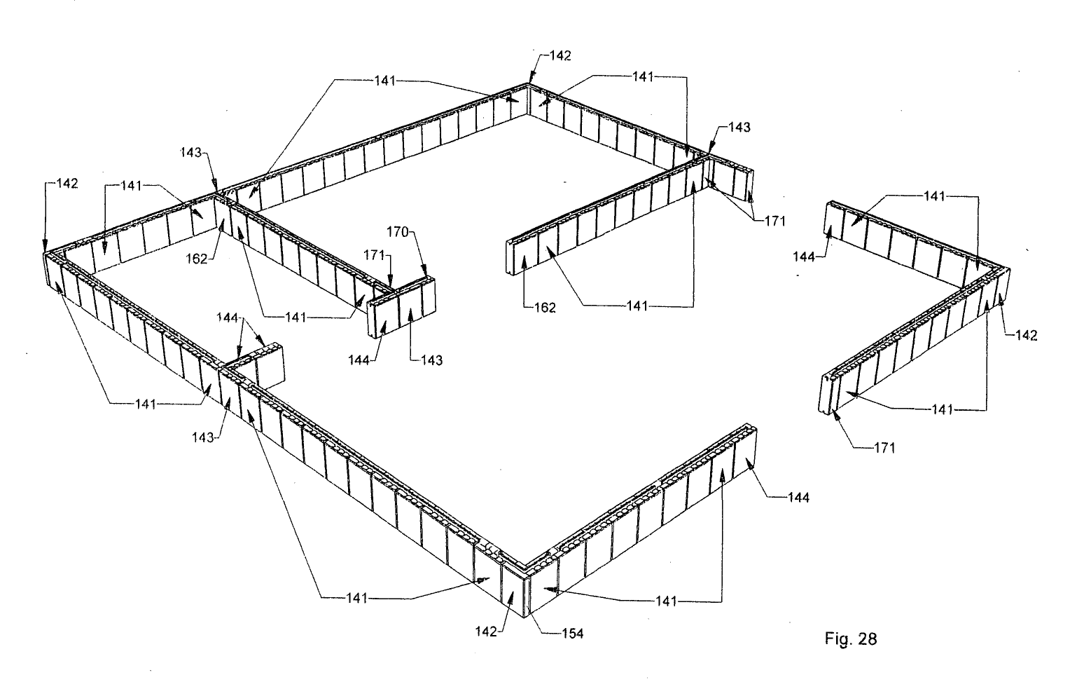

FIG. 28 is a perspective view similar to FIG. 27, but showing the second of the nine courses of the building structure of FIG. 18.

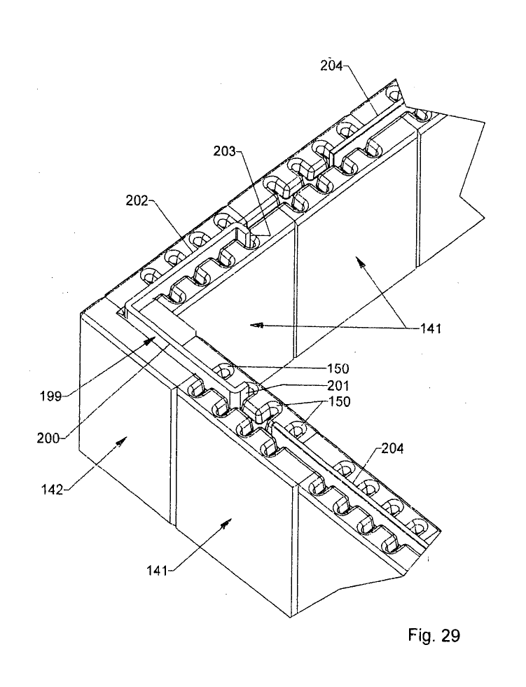

FIG. 29 is a view in perspective showing the left rear corner of the first course of the building structure of FIG. 18.

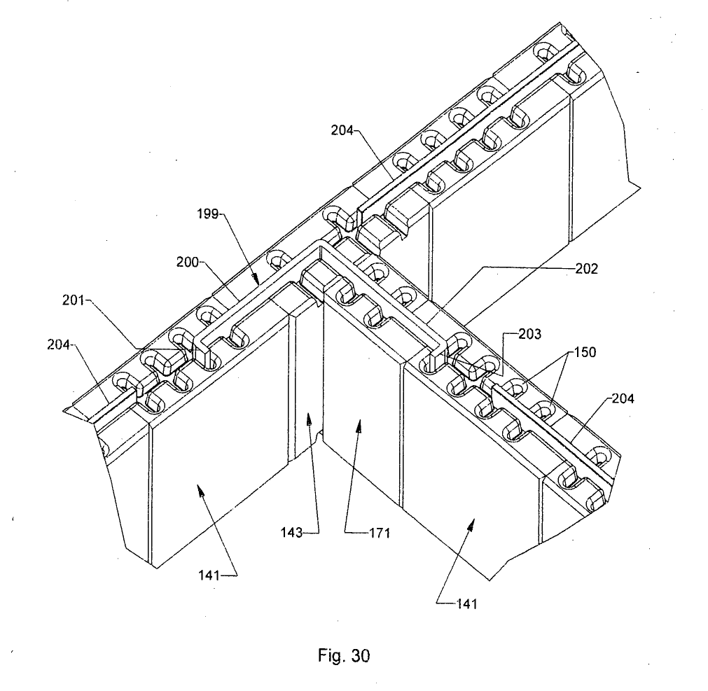

FIG. 30 is a perspective view showing the juncture of an exterior wall and an interior partition of the building structure of FIG. 18.

FIG. 31 is a view in perspective showing the left rear corner of the second course of the building structure of FIG. 18.

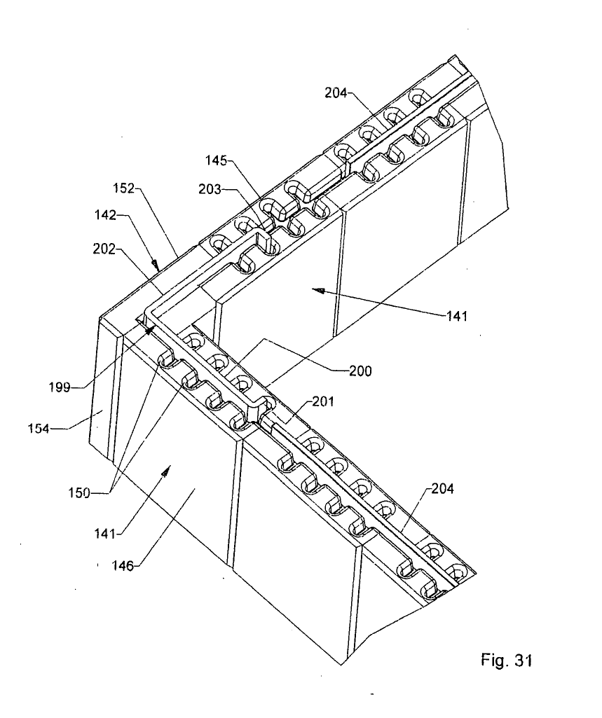

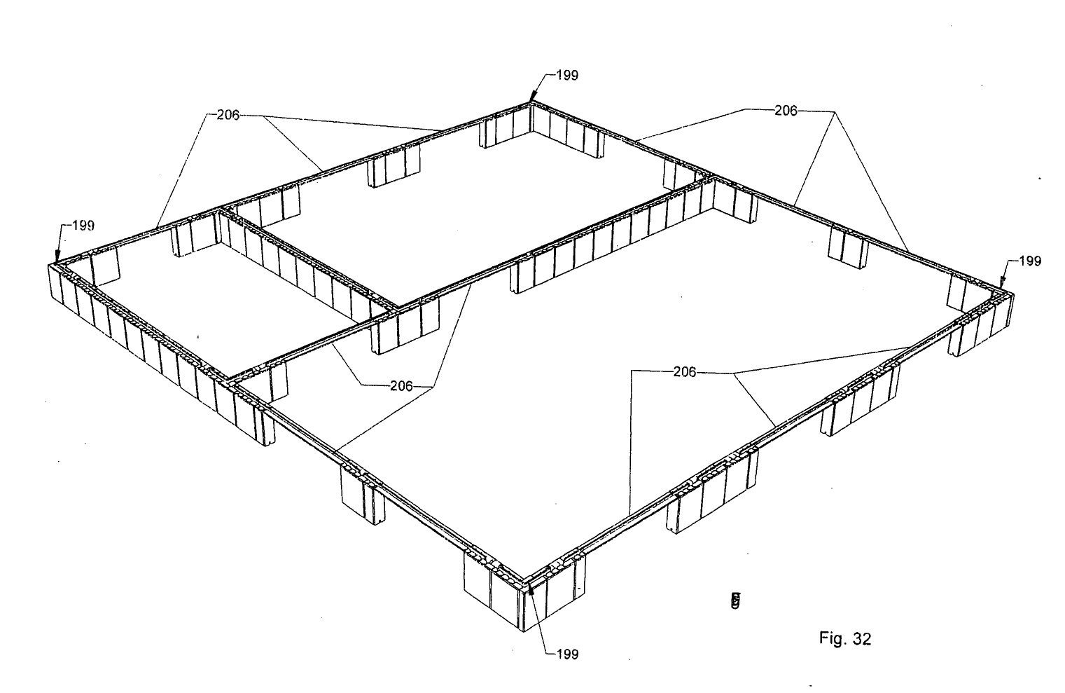

FIG. 32 is a perspective view showing the seventh course of the building structure of FIG. 18.

### DETAILED DESCRIPTION OF THE PREFERRED EMBODIMENTS

The instant invention, in one aspect, is a method for treating the liquid effluent from a septic tank and apparatus which is useful for practicing the method. Referring to FIG. 1, the liquid effluent from a septic tank, 10 is collected in a holding tank 11, from which it is pumped from time to time by a pump 12 to a receiver 13 in the bottom of a treatment vessel 14 that is packed with pebbles, grass fibers and sand. The pump 12 mixes air with the effluent it pumps to the receiver 13, which has a pervious top, so that air and effluent flow from the receiver 13 into the bottom of the vessel 14, which the effluent eventually fills to a predetermined level while the effluent in the vessel is aereated by the air. Thereafter, additional effluent causes a non-turbulent, upward movement thereof in the vessel 14 while air delivered with the effluent continues the aeration. Effluent delivered by the pump 12, when it reaches the top of the vessel 14, contacts and is heated by a heater 15, which is a combined solar collector and resistance heater. The effluent is heated by the heater 15 to effect pasteurization thereof (e.g., to 140° F. for twenty minutes), and may be heated to vaporize all or a portion thereof. Any effluent that is not vaporized by the heater 15 flows through an overflow drain 16 and is discharged to the environment for example onto the roof of a home (not illustrated) served by the septic tank 10.

In operation, sewage from a house (not illustrated) flows through a line 17 into the septic tank 10, where it separates into a lower layer of solids, a clear liquid layer above the solids, and an upper layer of scum. A part of the clear liquid layer flows from the septic tank through a line 18 to the holding tank 11. The EPA specifies that, for a three bedroom house with six occupants, the absorption area of a septic system shall be capable of accommodating a flow of 250 gallons per day of sewage, so that the flow of effluent through the line 18 to the tank 11, and from time to time, for example, every morning, through a line 19 to the receiver 13 amounts to 250 gallons or less per day. The flow therethrough from the tank 11 of effluent raises the level in the vessel 14 so that any pasteurized effluent that is not vaporized by the heater 15 is discharged, flowing through the drain 16. Pasteurization kills bacteria in the effluent, so that it is safe to discharge the pasteurized effluent from the tank 16 for mixture with ground water in the area, but does not remove nitrates and phosphorus compounds, so that some damage to the ecology is possible if it is discharged. Accordingly, evaporation of the effluent is preferred. The apparatus can also include an aerator (not illustrated) which pumps air through the line 19 to facilitate the action of aerobic bacteria in the vessel 14. Indeed, the pump 12 can be a combined pump and aerator which operates as a pump, as an aerator, or as both a pump and an aerator. A treatment vessel ten feet by three feet by eight feet is deemed adequate to treat 250 gallons per day of effluent. If desired, since treatment in the vessel 14 depends upon aerobic micro-organisms, aeration of the contents of the vessel can be used to increase the extent of purification achieved in an available vessel at a given flow rate.

Referring to FIG. 2, the treatment vessel 14, which is composed of walls 21, 22, 23 and 24, is shown as free standing, although it can be a part of a house, usually the house which generates the sewage that is treated. The walls 21, 22, 23 and 24 are assembled from especially fabricated blocks 25, 26 and 27.

The block 25 (see FIG. 3) has a bottom 28, a top 29, ends 30 and 31 and sides 32 and 33. There are longitudinally extending slots 34, 353, 6 and 37 in the bottom 28, the top 29, the end 30 and the end 31 of the block 25. There are also laterally extending slots 38 and 39 in the top 29. There are laterally extending slots (not illustrated) in the bottom 28 of the block 25 which are vertically aligned with the slots 38 and 39.

The block 27 (see FIG. 4) has a bottom 40, a top 41, ends 42 and 43 and sides 44 and 45. Slots 46, 47, and 48 extend longitudinally of the top 41, the end 43 and the bottom 40 of the block 27. There are also laterally extending slots 49 and 50 in the top 41 of the block 27 and laterally extending slots (not illustrated) in the bottom 40 which are vertically aligned with the slots 49 and 50.

The block 26 (see FIG. 5) has a bottom 51, a top 52, ends 53 and 54 and sides 55 and 56. Slots 57, 58, and 59 extend longitudinally of the top 52, the end 54 and the bottom 51 of the block 26. There is also a laterally extending slot 60 in the top 52 of the block 26 and a laterally extending slot (not illustrated) in the bottom 51 which is vertically aligned with the slot 60.

The blocks 25, 26 and 27 are similar to the block shown in FIGS. 34 and 35 of U.S. Pat. No. 6,769,220, Aug. 3, 2004. The blocks 25, 26 and 27 are made of concrete, and can be produced in appropriately shaped molds similar to the mold 133 of FIGS. 30-32 of said U.S. Pat. No. 6,769,220, by casting a cement thereinto and vibrating the mold so that the cement is homogeneous and is in intimate contact with all parts of the mold. The mold (not illustrated) in which the block 25 is produced has a flat bottom and a four sided ring which rests on the flat plate and has a first side shaped to form the end 30, and second, third and fourth sides shaped to form the top 29, the end 31 and the bottom 24 of the block, and can be closed by a cover which forms the side 33. Care should be taken to prevent adhesion between the cement and the surfaces of the mold which it contacts. Adhesion can be prevented by providing a polyethylene or equivalent surface on the mold surfaces, for example by using mold parts that have been produced from polyethylene by injection molding, or by using mold liners that have been produced from polyethylene by injection molding. The blocks 26 and 27 are also made of concrete, and can be produced in a similar way. The blocks 25, 26 and 27 can also be made partially with concrete and partially with a thermoset, cellular urethane as also disclosed in said U.S. Pat. No. 6,769,220.

Referring, again, to FIG. 2, longitudinal splines 61 lateral splines 62 and corner splines 63 are received, respectively, in slots in the blocks 95, 26 and 97 of the treatment vessel 14, which is erected on a foundation 64, to which the splines (not illustrated) are attached in the pattern shown on the top course of the portion of the vessel 14 that appears in the drawing, i.e., there is a corner spline 63 accurately positioned at each of the four corners of the vessel and there are splines 61 and 62 accurately positioned as shown to receive slots in the blocks 95, 26 and 27 of the first course. It will be noted that the slots in the bottom of the block 27 in the position shown in FIG. 4 do not match the pattern of the splines to the right of a cornier 65 (FIG. 2); instead, the block 27 in that location must be rotated 180° about its longitudinal axis from the position shown in FIG. 4 for installation. The adjacent block 25 can be installed in the rotational position shown in FIG. 3, but the next block 26, for installation, must be rotated 180° around its vertical axis from the position shown in FIG. 5. After the first course is installed on the splines attached to the foundation 63, a second course of splines is installed in the same pattern on blocks of the first course, and a second course of blocks is installed on those splines. In this course, one of the blocks 26 (FIG. 5), rotated 180° around its longitudinal axis, is the first block to the right of the corner 65; one of the blocks 25 is the second; and one of the blocks 27 rotated 180° around its vertical axis is the third. Additional splines and blocks are installed until the vessel 14 reaches the desired height.

It is desirable for there to be a steel cover (not illustrated) over the blocks in the top course of the vessel 14. The cover can rest on the tops of the blocks of the top course, and can have a cross section which is the shape of an inverted “U”. It is also desirable for the completed structure to be anchored at a plurality of points against vertical movement relative to the foundation. An excellent arrangement is a rectangular steel member which rests on, and is urged downwardly against, the blocks of the top course by a plurality of rods which are anchored to the foundation.

A fragment of another treatment vessel according to the invention is indicated generally at 68 in FIG. 6. The vessel 68 is assembled from blocks 69 (FIG. 7) and blocks 70 (FIG. 8).

A first course of the blocks 69 and 70 of the vessel 68 is erected on splines which are attached to a foundation and received in slots (not illustrated) in the bottoms of the blocks of the first course in the manner shown in FIG. 2. A second course is erected on splines which are received in slots 71 in the tops of the blocks 69 and 70 of the first course, and higher courses are erected on splines which are received in slots in the tops of the blocks of the course below (not illustrated) as also shown in FIG. 9. Desirably, there is a steel cover (not illustrated) over the blocks in the top course. The cover can rest on the tops of the blocks of the top course, and can have a cross section which is the shape of an inverted “U”. It is also desirable for the completed structure to be anchored at a plurality of points against vertical movement relative to the foundation. An excellent arrangement is a rectangular steel member which rests on, and is urged downwardly against, the blocks of the top course by a plurality of rods which are anchored to the foundation.

Referring to FIG. 7, the block 69 has opposed major surfaces 72 and 73, stepped ends 74 and 75, a top 76, and a bottom 77. The block 69 is symmetric about its horizontal axis and, except for lateral slots 78 in a stepped portion of the end 74 and longitudinal slots 79 in the end 75, is symmetric about its vertical axis. The block 70, as shown in FIG. 8, has opposed major surfaces 80 and 81, stepped ends 82 and 83, a top 84 and a bottom 85. A portion, designated 86, of the block 70 extends to the right in FIG. 8 beyond the rest of the block, and a portion, designated 87, extends to the left in FIG. 8 the same distance beyond the rest of the block. There are slots 88 in the portions 86 and 87 of the block 70. In the portion of a wall structure shown in FIG. 6, the slot 88 in the portion 87 of one of the blocks 70 is sometimes adjacent the slot 79 in one of the blocks 69, in which case the resulting portion of the slot 71 is designated 79-88. In other cases, the slot 88 in the portion 87 of one of the blocks 70 is adjacent the slot 78 in one of the blocks 69, and the resulting portion of the slot 71 is designated 78-88. In still another case, the slot 88 in the portion 87 of one of the blocks 70 is adjacent the slot 88 in another of the blocks 70, and the resulting portion of the slot 71 is designated 88-88.

Liquid effluent from a septic tank can be treated in treatment vessels having the wall structures of FIGS. 2 and 6 which have been packed with pebbles, glass beads or the like by a method which comprises the steps of pumping the liquid effluent to the bottom of the treatment vessel so that, after the vessel is filled to a predetermined level, pumping additional effluent to the bottom thereof causes a non-turbulent, upward movement of the effluent in the vessel, withdrawing treated effluent from the upper portion of the vessel at substantially the rate at which the effluent is pumped to the bottom of the treatment vessel, and pasteurizing the treated effluent withdrawn from the upper portion of the vessel, the rate at which liquid effluent is pumped to the bottom of the treatment vessel being sufficiently low that the treated effluent withdrawn from the upper portion of the vessel is substantially devoid of organic material.

Referring, again, to FIG. 6, it will be noted that the slots 71, 78-88, 79-88, and 88-88 in the tops of the blocks 69 and 70 are aligned so that they form a continuous slot which is rectangular in plan view, and extends around the top of the first course of blocks of the treatment vessel 68. A single spline which has the same rectangular shape in plan view is received in these slots, and locks the blocks 69 and 70 of the first course against outward movement. There are also aligned slots (not illustrated) in the bottoms of the blocks 69 and 70 which are vertically aligned with the slots 71, 78-88, 79-88 and 88-88; these slots receive a single spline which has the same rectangular shape, and is suitably attached to a foundation (not illustrated) for the processor 68. Similarly, slots in the bottoms of the blocks of a second course receive the spline in the tops of the blocks of the first course, and are locked by that spline against movement relative to the blocks of the first course, and against outward movement. In like manner, the blocks of each of the other courses of the vessel 68 are locked against outward movement and against movement relative to the blocks of the course therebelow or therebelow and thereabove, as the case may be. In another embodiment of the instant invention, the splines on top of each course of blocks are generally “U” shaped in plan view, and there are two such splines on top of each course of the vessel. Each of these splines prevents outward movement of only two opposed ones of the four walls, but splines in other courses are rotated 90° in plan so that they prevent outward movement of the other two of the opposed ones of the four walls.

Another treating vessel according to the invention is indicated generally at 91 in FIG. 9. The walls of the vessel 91 are composed of corner blocks 92 and wall blocks 93. The corner blocks 92, as shown in FIG. 15, have opposed major surfaces 94 and 95, each of which is sometimes on the outside and sometimes on the inside of a structure in which one of the blocks is installed. The blocks also have edges 96 and 97, tops 98 and bottoms 99, all of which are adjacent the major surface 94 and edges 100 and 101, tops 102 and bottoms 103, all of which are adjacent the major surface 95. The wall blocks 93, as shown in FIG. 14, have opposed major surfaces 104 and 105, each of which is sometimes on the outside and sometimes on the inside of a structure in which the blocks are installed. The blocks also have edges 106 and 107, tops 108 and bottoms 109, all of which are adjacent the major surface 104 and edges 110 and 111, tops 112 and bottoms 113, all of which are adjacent the major surface 105.

The first step in producing the treating vessel 91 is to pour a concrete foundation 114 (FIG. 10) with a metal spline assembly 115 embedded therein. The upper surface of the foundation must be level, and a spline 116 which is a part of the spline assembly 115 must be level and dimensionally accurate. The spline assembly has a plate 117 in each corner, and a socket 118 welded or otherwise attached to each plate. After the concrete of the foundation 114 has cured adequately, a first course of blocks is assembled on the spline 1116, as shown in FIG. 11. Referring, also, to FIG. 15, the first step of assembling the first course of blocks involves fitting a slot 119 of a block 92 over the spline 116 with the edge 96 on the near end and the major surface 94 on the right. The bottom of the block 92 is the mirror image of the top, which is seen in FIG. 15. The rest of the blocks in the first course between the block 92 and a corner 120 of the structure are all blocks 96 (FIG. 14). A slot 121 of one of the blocks 96 is fitted over the spline 116 with the edge 107 adjacent the previously installed block 92 and the major surface 105 on the right. The bottom of the block 92 is the mirror image of the top, which is seen in FIG. 14. The other three walls of the first course have one block 92 with its major surface 94 facing the outside of the structure, and six blocks 93 with their major surfaces facing as indicated by reference numerals in FIG. 11. They are assembled in the manner just described. Indeed, each wall of each course is composed of a block 92 at one end and six adjacent blocks 93. The major surface 94 of each block 92 faces the outside of the structure; the major surface of each block 93 which is adjacent a block 92 faces the inside of the structure; and the major surface 105 of each of the other blocks 93 in each row faces either the outside or the inside, the opposite of the adjacent blocks in that row. The block 93 on an end of each row adjoins a block 92 in the same row, but on a different side of the structure 91.

There are splines on the tops of all except the tenth row of blocks in the treating vessel 91 of FIG. 9. The spline arrangement on top of row 1 is the same as the spline arrangement on top of rows 3, 5, 7 and 9. The spline arrangement on top of row 5, as shown in FIG. 13, has angled tips 122 which lock the blocks in the fifth course against lateral movement away from adjacent blocks. Similarly, the spline arrangement on top of row 4 is the same as the spline arrangement on top of rows 2, 6, and 8. The spline arrangement on top of row 4, as shown in FIG. 12, has angled tips 123 which lock the blocks in the sixth course against lateral movement away from adjacent blocks. The locking action of the tips 122 and 123 is a consequence of their being received in lateral slots 123 in the blocks 93, FIG. 14.

U-channels 124 and U shaped corner members 125 (See FIG. 16) cover the top course of blocks in the vessel 91. The channels 124, which have webs 126 and sidewalls 127, fit snuggly over the blocks of the tenth course, while the corner members 125, which have webs 128 and sidewalls 129, fit snuggly over the corners of that course. Triangular plates 130 are welded or otherwise attached to the interior sidewalls 129 of the corner members 125. Threaded ends of rods 131, which are locked against longitudinal movement inside sockets 118 (FIG. 10) extend through holes 132 in the plates 130 so that nuts can be turned onto the threaded ends to apply a compressive force to the entire treating vessel 91.

Referring to FIG. 17, the treating vessel 91 has absorbing panels 133 for solar energy. These panels are suspended from hooks 134 which are attached to the sidewalls 127 of two of the U-channels. A transparent cover, which is clamped by a metal strap 135 to the top of the treating vessel 91, protects the contents against rain, but does not prevent treated effluent which is vaporized from being vented to the atmosphere. A supplemental heater can be used with the vessel 91, or a drain can be provided through which purified liquid which reaches the top of the vessel can be discharged from the system.

A waterproof liner 136 (FIGS. 16 and 17) contains the liquid contents of the treating vessel 91. i.e., the septic tank effluent charged, and the products of its treatment, preventing leakage before the liquid reaches the top of the vessel 91 and is vaporized or otherwise discharged from the vessel. The liner 136 can be made from plastic-coated fabric by cutting and sewing and then waterproofing the seams, for example, with the plastic of the plastic-coated fabric. The “plastic” of the plastic-coated fabric can be, without limitation, a polyolefin, a polyester, a polyamide, a polyurethane, a polycarbonate, a thermoplastic elastomer, a high temperature polymer, or a blend of such materials.

A structure indicated generally at 137 in FIG. 18 constitutes the first nine courses of a house constructed from blocks which have longitudinally extending slots in their upper and lower surfaces to receive splines. The blocks of the first course of the structure 137 are installed on splines 138 (FIG. 19), which are parts of base strips 139. The base strips 139 are attached to a concrete foundation 140 in a precisely controlled pattern and are carefully leveled so that the blocks of the first course are properly positioned when, as subsequently explained, they are installed thereon. Referring, again to FIG. 18, the walls of the structure 137 are composed of blocks 141 (see, also, FIGS. 20 and 27), 142 (see, also, FIGS. 22 and 27), 143 (see, also, FIGS. 21 and 27) and 144 (see, also, FIGS. 94 and 27), or, as subsequently discussed in more detail, similarly shaped blocks of different sizes.

The block 141 (FIG. 20) has opposed, parallel major surfaces 145 and 146 which are offset longitudinally of the block from one another, so that a portion 147 of the block adjacent the surface 145 extends longitudinally of the block in a first direction beyond the surface 146 and a portion 148 of the block adjacent the surface 146 extends longitudinally of the block in the opposite direction beyond the surface 145. There is a longitudinally extending recess 149 in the top of the block to receive a spline and there are spaced lateral recesses 150 to receive lateral portions of a spline or of splines. There are also longitudinally extending and lateral recesses in the bottom of the block 141 which are vertically aligned with the recesses 149 and 150 in the top.

The block 142 (FIG. 22) has opposed, parallel major surfaces 151 and 152 which are offset longitudinally of the block from one another, so that a portion 153 of the block adjacent the surface 152 extends longitudinally of the block in a first direction beyond the surface 151 and a portion 154 of the block which is also adjacent the surface 152 extends longitudinally of the block in the opposite direction beyond the surface 151. There is a longitudinally extending recess 155 in the top of the block to receive a spline. There is also a longitudinally extending recess in the bottom of the block 142 which is vertically aligned with the recess 155 in the top.

The block 143 (FIG. 21) has opposed, parallel major surfaces 156 and 157 which are offset longitudinally of the block from one another, so that a portion 158 of the block adjacent the surface 156 extends longitudinally of the block in a first direction beyond the surface 157 and a portion 159 of the block adjacent the surface 157 extends longitudinally of the block in the opposite direction beyond the surface 156. There is a longitudinally extending recess 160 in the top of the block to receive a spline and there are spaced lateral recesses 161 to receive lateral portions of a spline or of splines. There are also longitudinally extending and lateral recesses in the bottom of the block 143 which are vertically aligned with the recesses 160 and 161 in the top.

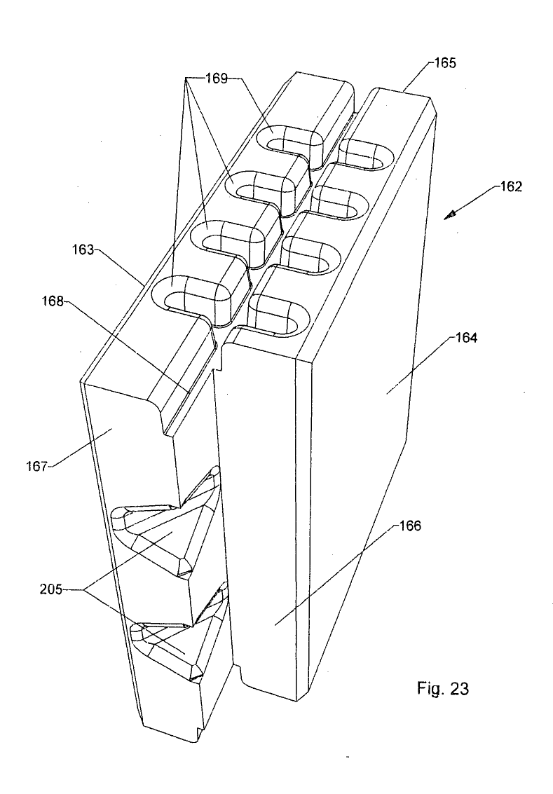

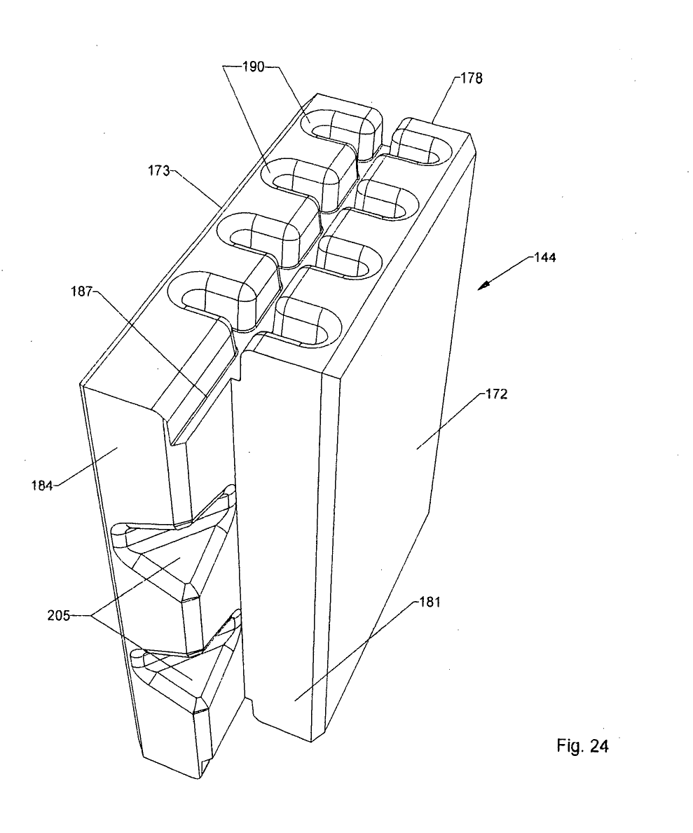

A block 144 (FIG. 24) has opposed, parallel major surfaces 172 and 173 and an end 178 which is perpendicular to the surfaces 172 and 173. A portion of the block adjacent the surface 172 extends a given distance, longitudinally of the block, to an end 181 which is perpendicular to the surface 172 and parallel to the end 178, while a second portion of the block adjacent the surface 173 extends a greater distance, longitudinally of the block, to an end 184 which is perpendicular to the surface 173 and parallel to the end 178. There is a longitudinally extending recess 187 in the top of the block to receive a spline and there are four spaced lateral recesses 190 to receive lateral portions of a spline or of splines. There are also longitudinally extending and lateral recesses in the bottom of the block 144 which are vertically aligned with the recesses 187 and 190 in the top.

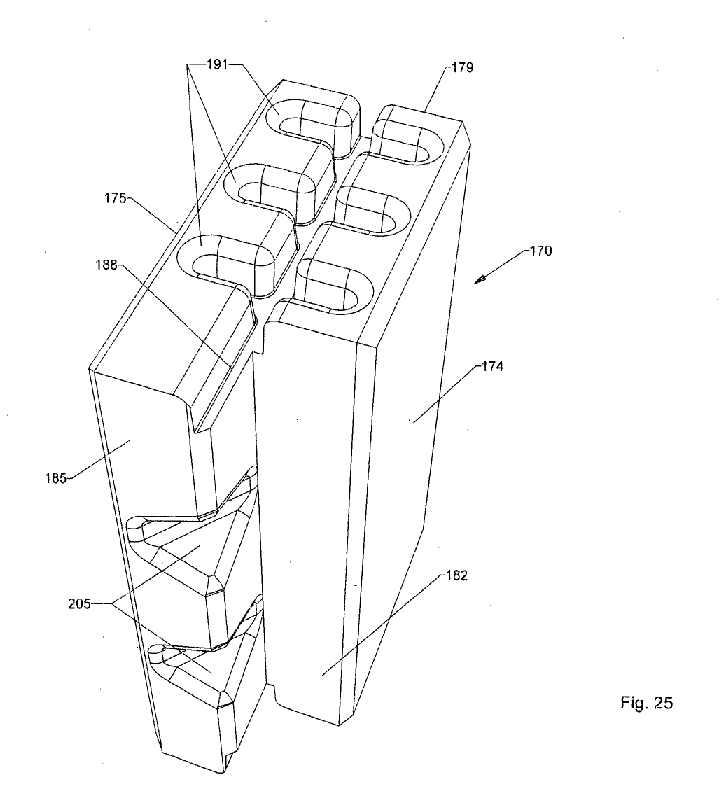

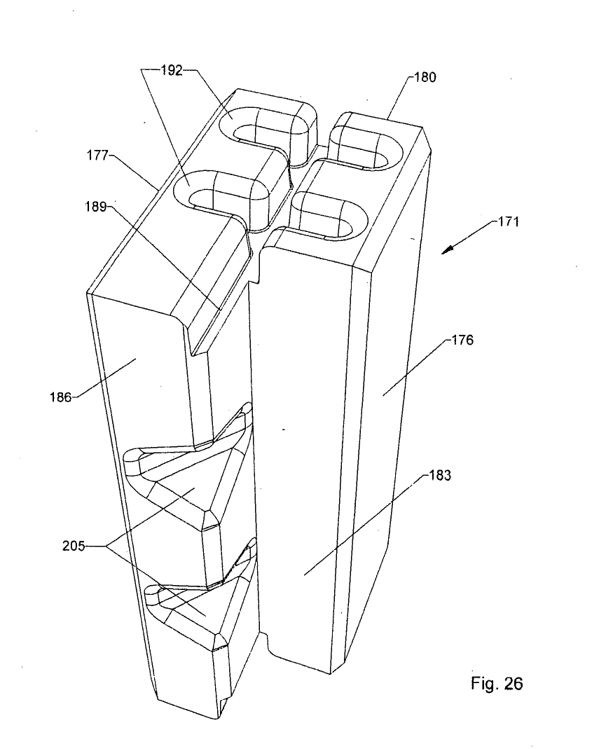

The blocks 162 (FIG. 23), 170 (FIG. 25) and 171 (FIG. 26) are similar to the blocks 144 of FIG. 24. The former blocks have opposed, parallel major surfaces 163 and 164, 174 and 175, and 176 and 177, and ends 165, 179 and 180 which are perpendicular to the respective major surfaces. A portion of each block adjacent the major surface 164, 174 or 176 extends a given distance, longitudinally of the block, to an end 165, 182 or 183 which is perpendicular to the surface 164, 173 or 175 and parallel to the end 165, 179 or 180, while a second portion of the block adjacent the surface 163, 175 or 177 extends a greater distance, longitudinally of the block, to an end 167, 185 or 186 which is perpendicular to the surface 164, 175 or 177 and parallel to the end 165, 179 or 180. There are longitudinally extending recesses 168, 188 and 189 in the tops of the blocks to receive splines and there are spaced lateral recesses 169, 191 and 192 to receive lateral portions of splines. There are also longitudinally extending and lateral recesses in the bottoms of the blocks 162 170 and 171 which are vertically aligned with the recesses in the tops.

The first step in producing the structure 137 of FIG. 18 is to pour and accurately level the foundation 140 (FIG. 19), and the next step is to attach the base strips 139 to the foundation so that the blocks of the first course, when the splines 138 are received in the slots in their bottoms, are accurately positioned, as required.

The next step in producing the structure 137 is to position door frames 193, 194, 195 and 196 and the blocks of the first course so that the splines 138 which have been installed are received in the slots in the bottoms of the blocks. The door frames, which are chapels opening outwardly of the frames, having webs 197 and side-walls 198, are accurately positioned and attached by threaded members (not illustrated) to the base strip 139 (FIG. 19).

The next steps are to position the blocks in the proper positions on the spline 138 and on previously positioned blocks. In doing this, it is necessary to take the rotational position of each block into consideration. For example, the blocks 171, 170, 144 and 162 all have stepped ends so that the blocks are longer on their left sides in the positions shown in FIGS. 26, 25, 24 and 23. However, these blocks, when they are rotated 180° about a longitudinal axis, are longer on their right sides than on their left.

FIG. 27 shows the blocks in the first course of the building 137. The following blocks are in the first course, and each is shown by the drawing identified parenthetically after its reference numeral: block 141 (FIG. 20), block 142 (FIG. 22), block 143 (FIG. 21), block 144 (FIG. 24), block 162 (FIG. 23), block 170 (FIG. 25) and block 171 (FIG. 26). Blocks 141 make up most of the walls of the first course. In addition, there is a block 142 at each corner, and there are blocks 143 in three of the sidewalls. As is subsequently explained in more detail, splines attach the ends of interior partitions to the blocks 143. There are also blocks 144 and 171 in the first course, adjacent the door frames 193 and 196

The first courses of interior partitions of the building 137 are also shown in FIG. 7. These partitions are composed of blocks 141, 143, 144, 162, 170, and 171.

As stated above, there is a block 142 in the first course at each of the four corners of the building 137. As shown in more detail in FIG. 29, there is a block 141 adjacent the block 142 in each of the walls which meet at the left corner. These blocks are in the rotational positions (about their longitudinal axes) shown in FIG. 20 so that one of their portions 147 and 148 abuts the block 142. Blocks 141 (see, also, FIG. 27) and one of the blocks 143 extend from the left corner shown in FIG. 29 to the rear corner, which has the same configuration as the left corner, but is rotated 90°, clockwise. Blocks 141, one of the blocks 143, and one of the blocks 144 extend from the rear corner to the door frame 196 and a block 171 and blocks 141 extend from the door frame 196 to the right corner of the building, which has the same configuration as the rear corner, but is rotated 90°, clockwise. Blocks 141, and one of the blocks 144 extend from the right corner to the door frame 193 and a block 171 and blocks 141 extend from the door frame 193 to the near corner of the building, which also has the same configuration as the right corner, but is rotated 90°, clockwise. Blocks 141 and one block 143 extend from the near corner to the left corner. Finally, there are blocks 141, 143, 144, 162 and 170 in the first courses of the interior partitions. In the first course, all of the blocks mentioned in this paragraph are in the rotational positions (about their longitudinal axes) in which they are shown in FIGS. 20, 21, 22, 23, 24, 25 and 26.

FIG. 28 shows the blocks in the second course of the building 137, including the interior partitions. Blocks 141 also make up most of the walls of the second course.

There is a block 142 in the second course at each of the four corners of the building 137. As shown in more detail in FIG. 31, the block 142 in the left corner is positioned so that its major surface 152 is exposed in the rear wall of the building, and there is a block 141 adjacent the block 142 in each of the walls which meet at that corner. The blocks 141 have been rotated 180° (about their longitudinal axes) from the rotational position shown in FIG. 20 so that one of their portions 147 and 148 abuts the block 142 and the major surface 146 is on the outside of the wall from the near corner to the left corner, and the major surface 145 is on the outside of the wall from the left corner to the rear corner. Blocks 141 (see, also, FIG. 28) and one of the blocks 143 (all rotated 180°) extend from the left corner shown in FIG. 28 to the rear corner which has the same configuration as the left corner, but is rotated 90°, clockwise. Blocks 141, one of the blocks 143, and one of the blocks 171, all rotated 180°, extend from the rear corner to the opening for the door frame 196 and a block 144 and blocks 141 (all rotated 180°) extend from the opening for the door frame 196 to the right corner of the building, which has the same configuration as the rear corner, but is rotated 90°, clockwise. Finally. Blocks 141, and one of the blocks 171 (rotated 180°) extend from the right corner to the opening for the door frame 193 and a block 144 and blocks 141 (rotated 180°) extend from the opening for the door frame 193 to the near corner of the building, which also has the same configuration as the right corner, but is rotated 90°, clockwise. Finally, there are blocks 141, 143, 144, 162 and 170 in the second courses of the interior partitions.

The corners of the third, fifth, seventh and ninth courses of the building 137 have the same configuration as those of the first course, and the corners of the fourth, sixth and eighth courses have the same configuration as those of the second course. The rest of the blocks in each course are shaped, oriented, sized and positioned so that the several courses constitute the structure 137.

The blocks of the first course have recesses in their bottoms which, as assembled, receive the spline 138 (FIG. 19), and recesses in their tops which receive splines as subsequently described in more detail. The blocks of the second and higher courses have recesses in their bottoms which receive the splines which are installed in recesses of the course below, and recesses in their tops which receive splines that are also received in the course above.

In the erection of the building, after the blocks of the first course have been positioned as described above on the splines 138 (FIG. 19), splines of different designs are installed in the slots in the tops of the blocks of the first course. One of these splines, which is indicated generally at 199 in FIG. 29 is received in the longitudinally extending recess in the top of the block 142 (FIG. 27) in the left corner of the first course, and in the top of the adjacent block 141 on each side of the block 142. The spline 199 has a leg 200 which extends to the right of the block 149 and into the recess 149 (see, also FIG. 20) in the top of the adjacent block 141, and has a tip 201 which is received in one of the lateral recesses 150 of the adjacent block 141. The spline 199 also has a leg 202 which extends at a right angle to the leg 200 beyond the block 142 and into the recess 149 in the top of the adjacent block 141 in the back wall of the building. The leg 202 of the spline 199 has a tip 203 which is received in one of the lateral recesses 150 of the adjacent block 141 in the back wall of the building.

As also shown in FIG. 29, there are longitudinally extending splines 204 in the slots in the tops of the first course blocks in the wall between the near corner and the left corner and in the back wall of the building. One of the splines 204 extends through about half of the slot in the top of the second block 141 in the back wall, through the slots in the tops of the next three blocks 141 and into the slot in the top of the sixth one of the blocks 141, where it terminates (see FIG. 30). The leg 200 of another spline 199 is also received in the slot 149 in the top of the sixth block 141, while the leg 209 of that spline is received in the slots of adjacent blocks 171 and 141 in the interior partition. The leg 202 of the spline 199 extends longitudinally of the block 171 and into the recess 149 in the top of the adjacent block 141 in the partition, where its tip 203 is received in one of the lateral recesses 150 of the adjacent block 141.

There are splines 199 at each of the corners of each course. The structures at the other corers of the first course are the same as that shown and described at the left corner, but rotated clockwise 90° at the far corner, rotated 180° clockwise at the right corner, and 270° clockwise at the near corner. There is a spline 199 associated as described with each block 142 of each corner.

There are also splines 199 at each intersection of two walls, and longitudinal splines 204 between the splines 199. The spline arrangements are similar to that shown in FIG. 30, and described above with reference thereto, differing from one another mainly with respect to the position, longitudinally of the block 143 of the intersection of the two legs 200 and 202 of the spline 199.

The corners of the second course of the structure 137, as discussed above, are different from the corners of the first course. In the second course, at the left corner of the building, as shown in FIG. 31, a block 142 is positioned so that its major surface 152 faces the real of the building, its end 154 is at the end of the wall from the near corner to the left corner, and two of the blocks 141 are adjacent that block 142. One of the adjacent blocks 141 is positioned in the wall from the near corner to the left corner so that its major surface 146 faces the exterior of the structure, and the other is positioned in the wall from the left corner to the rear corner so that its major surface 145 faces the exterior. These blocks are rotated 180° about their longitudinal axes from their positions in the first course, as shown in FIG. 27. The structures at the other corners of the second course are the same as that shown and described at the left corner, but rotated clockwise 90° at the far corner, rotated 180° clockwise at the right corner, and 270° clockwise at the near corner. There is a spline 199 associated as described with each block 142 of each corner.

The corners of the third, fifth, seventh and ninth courses of the building 137 are the same as those of the first course, and the corners of the fourth, sixth and eighth courses are the same as those of the second course.

When two of the blocks 141, 143, 144, 162, 170 and 171 are required to abut, their rotational positions about their longitudinal axes must be matched so that the two nest as shown in the within drawings.

The other courses of the structure 137 are composed of the blocks 141, 142, 143 and, where required to control the lengths of the walls and partitions, one or more of the blocks 144, 162, 170 and 171.

Blocks 162 (FIG. 23), 144 (FIG. 24) 170 (FIG. 25) and 171 (FIG. 26) are used as required to accommodate the windows in the fifth, sixth and seventh courses of the building.

There are recesses 205 in surfaces of the blocks 141 (FIG. 20), 143 (FIG. 21), 142 (FIG. 22), 162 (FIG. 23), 144 (FIG. 24), 170 (FIG. 25), and 171 (FIG. 26) which are inside a wall when the blocks are assembled as described above. There are also similar recesses at the opposite ends of the blocks 141 (FIG. 20), 143 (FIG. 21), and 142 (FIG. 22). These recesses are formed by corresponding raised portions of light weight molds in which the blocks are cast. The raised portions are useful because they strengthen the molds, but the recesses in the blocks serve no useful purpose.

Referring to FIG. 27, the walls to the right of the near corner, to the right of the left corner, and to the left of the door frame 194 can be lengthened by a few blocks, a new partition can be installed from the partition to the left of the door frame 194 to the wall from the left corner to the back corner, and apparatus for treating septic tank effluent, as previously described, can be installed in the windowless closed space which results.

As shown in FIG. 32, splines 206 which span window and door openings are advantageously used in the seventh course of the building. The splines 206 are received in the slots in the tops of the blocks of the seventh course on opposed sides of the openings and in the slots in the bottoms of the blocks (not show on FIG. 32) of the eighth course.

Tensioned rods can be installed between the foundation and the tops of the walls to place the building structure 137 under compression, and thereby increase its strength. Such rods, designated 207, are shown in FIG. 18 in the rear corner of the building 137, adjacent the door frame 196, at the intersections of interior partitions and exterior walls and between windows in the wall from the left corner of the building to the rear corer. Such rods are also advantageous in the other corners of the building, on both sides of the door frame 193, and between the windows in the wall from the near corner to the left corner of the building. Fittings 208 to receive the rods 207 are shown in FIG. 19 at each of the corners of the spline 138. Grooves which extend around the blocks 141 and 143, in their tops, bottoms and ends, can also be provided, and stepped rods received in some of those grooves can be used as described in U.S. Pat. No. 6,769,220 to anchor the blocks of the building structure 137 against upward movement.

In its essential details, the invention, in one aspect, is a method for treating the liquid effluent from a septic tank. The method involves the steps of pumping the liquid effluent to the bottom of a treatment vessel that is packed with pebbles, glass beads or the like. First, the vessel is filled to a predetermined level. Thereafter, pumping additional effluent to the bottom thereof causes a non-turbulent, upward movement of the effluent in the vessel. Treated effluent is withdrawn from the upper portion of the vessel at substantially the rate at which the effluent is pumped to the bottom of the treatment vessel, and the withdrawn treated effluent is pasteurized. The rate at which liquid effluent is pumped to the bottom of the treatment vessel is sufficiently low that the treated effluent withdrawn from the upper portion of the vessel is substantially devoid of organic material, and can be discharged without harm to the environment.

In another aspect, the invention is an improvement to a rectangular or square building structure. The building comprises a foundation which has a substantially planar and horizontal upper surface, and a plurality of courses of blocks which form the walls of the building. The blocks have longitudinally extending slots in their bottoms and tops in which metal strips are received. The metal strips in the slots in the bottoms of the blocks in the first course are attached to and extend upwardly from the upper surface of the foundation. The metal strips are effective to lock the blocks of the first course against lateral movement relative thereto. There are also second and subsequent metal strips which are received in the slots in the tops of the blocks of the first and higher courses and in the bottoms of the second and higher courses. The second and subsequent metal strips are effective to lock the blocks in whose slots they are received against lateral movement relative to the strips. The improvement of the invention, in one specific instance, comprises a metal strip which is received in and locked against lateral movement relative to the slots of adjacent blocks of two different walls of the building, and means for preventing longitudinal movement of the strip relative to at least one of the slots in which it is received, thereby resisting movement of the corner of each of the walls away from the adjacent wall. For example, as shown in FIG. 2, blocks 89 and 90 meet at the corner 65 of the vessel 14, where one of the splines 63 locks the block 90 against movement to the right, away from the block 89, and also locks the block 89 against similar movement away from the block 90. There is a spline 63 at each of the corners of each of the courses of the vessel 14 so that outward movement of each of the walls is effectively prevented.

In a preferred embodiment, the invention is a block having a body part which is right rectangular parallelepipedal in shape, has a top, a bottom and first and second body part sidewalls, has parallel, longitudinally extending spline-receiving grooves in its top and bottom, and has an integral extension with a top, a bottom, and a first extension sidewall which are extensions of the top, the bottom and the first of said body part sidewalls, a second extension sidewall which is parallel to said first extension sidewall, and spaced therefrom by half the distance between the first and second body part sidewalls, and an end which is perpendicular to the longitudinal axis of said body part, wherein said body part has an end adjacent said integral extension which is perpendicular to the longitudinal axis of said body part and an opposed end which is either perpendicular to the longitudinal axis of said body part or is a second integral extension of said body part with a top, a bottom, and a third extension sidewall which are extensions of the top, the bottom and the first or the second of said body part sidewalls, a fourth extension sidewall which is parallel to said third extension sidewall, and spaced therefrom by half the distance between the first and second body part sidewalls, and an end which is perpendicular to the longitudinal axis of said body part, and said body part has an end adjacent said integral extension which is perpendicular to the longitudinal axis of said body part.

In another preferred embodiment, the improvement of the invention is a metal strip which is received in and locked against lateral movement relative to the slots of adjacent blocks of two different walls of the building, and means for preventing longitudinal movement of the strip relative to both of the slots in which it is received.

A block having rectangular front and back major surfaces which are parallel to one another, and have opposed parallel edges, two of which are vertically aligned, and two of which are separated by a distance of D and are vertically misaligned so that the horizontal projection of the vertical distance from each of the misaligned edges to the edge relative to which it is misaligned is one half of D, said block having a planar top and a planar bottom, each of which connects two of said vertically aligned parallel edges, and matching stepped ends so that the ends of two of said blocks can be fit together so that the two blocks constitute a part of a wall.

It will be appreciated that various changes and modifications can be made to the apparatus and method specifically disclosed herein without departing from the spirit and scope of the invention.

I claim:

1. A method for treating the liquid effluent from a septic tank, said method comprising the steps of pumping the liquid effluent to the bottom of a treatment vessel that is packed with pebbles, glass beads or the like so that, after the vessel is filled to a predetermined level, pumping additional effluent to the bottom thereof causes a non-turbulent, upward movement of the effluent in the vessel, withdrawing treated effluent from the upper portion of the vessel at substantially the rate at which the effluent is pumped to the bottom of the treatment vessel, and pasteurizing the treated effluent withdrawn from the upper portion of the vessel, the rate at which liquid effluent is pumped to the bottom of the treatment vessel being sufficiently low that the treated effluent withdrawn from the upper portion of the vessel is substantially devoid of organic material.

2. In a rectangular or square building structure comprising a foundation having a substantially planar and horizontal upper surface, a plurality of courses of blocks forming the walls of the building, the blocks having longitudinally extending slots in their bottoms and tops metal strips received in the slots in the bottoms of the blocks in the first course, and attached to and extending upwardly from the upper surface of the foundation, the metal strips being effective to lock the blocks of the first course against lateral movement relative thereto, second and subsequent metal strips received in the slots in the tops of the blocks of the first and higher courses and in the bottoms of the second and higher courses, the second and subsequent metal strips being effective to lock the blocks in whose slots they are received against lateral movement relative the strips the improvement of means operatively associated with each of the walls of the building, and operable to resist movement of the corner of each of the walls away from the adjacent wall.

3. In a rectangular or square building structure, the improvement claimed in claim 2 wherein said means operable to resist movement of the cornet of each of the walls away from the adjacent wall comprises a metal strip which is received in and locked against lateral movement relative to the slots of adjacent blocks of two different walls of the building, and means for preventing longitudinal movement of said strip relative to at least one of the slots in which it is received.

4. In a rectangular or square building structure, the improvement claimed in claim 2 wherein said means operable to resist movement of the corner of each of the walls away from the adjacent wall comprises a metal strip which is received in and locked against lateral movement relative to the slots of adjacent blocks of two different walls of the building, and means for preventing longitudinal movement of said strip relative to both of the slots in which it is received.

5. A block having rectangular front and back major surfaces which are parallel to one another, and have opposed parallel edges, two of which are vertically aligned, and two of which are separated by a distance of D and are vertically misaligned so that the horizontal projection of the vertical distance from each of the misaligned edges to the edge relative to which it is misaligned is one half of D, said block having a planar top and a planar bottom, each of which connects two of said vertically aligned parallel edges, and matching stepped ends so that the ends of two of said blocks can be fit together so that the two blocks constitute a pair of a wall.

6. In a rectangular or square building structure comprising a foundation having a substantially planar and horizontal upper surface, a plurality of courses of blocks forming the walls of the building, the blocks having longitudinally extending slots in their bottoms and tops, metal strips received in the slots in the bottoms of the blocks in the first course, and attached to and extending upwardly from the upper surface of the foundation, the metal strips being effective to lock the blocks of the first course against lateral movement relative thereto, second and subsequent metal strips received in the slots in the tops of the blocks of the first and higher courses and in the bottoms of the second and higher courses, the second and subsequent metal strips being effective to lock the blocks in whose slots they are received against lateral movement relative the strips, the improvement of means operatively associated with each of the walls of the building, and operable to resist movement of the corner of each of the walls away from the adjacent wall.

7. A block having a body part which is right rectangular parallelepipedal in shape, has a top, a bottom and first and second body part sidewalls, has parallel, longitudinally extending, spline-receiving grooves in its top and bottom, and has an integral extension with a top, a bottom, and a first extension sidewall which are extensions of the top, the bottom and the first of said body part sidewalls, a second extension sidewall which is parallel to said first extension sidewall, and spaced therefrom by half the distance between the first and second body part sidewalls, and an end which is perpendicular to the longitudinal axis of said body part, wherein said body part has an end adjacent said integral extension which is perpendicular to the longitudinal axis of said body part and an opposed end which is either perpendicular to the longitudinal axis of said body part or is a second integral extension of said body part with a top, a bottom, and a third extension sidewall which are extensions of the top, the bottom and the first or the second of said body part sidewalls, a fourth extension sidewall which is parallel to said third extension sidewall, and spaced therefrom by half the distance between the first and second body part sidewalls, and an end which is perpendicular to the longitudinal axis of said body part, and said body part has an end adjacent said integral extension which is perpendicular to the longitudinal axis of said body part.

8. A building structure comprising a corner block and two wall blocks, said corner block having opposed sidewalls and stepped ends, and being composed of first and second essentially right rectangular parallelepipedal portions which are integral with one another, and each of which has a given width and a given thickness, the first of said portions having a given length and the length of the second of said portions being the given length plus two times the given thickness, wherein one of the major surfaces of said first right rectangular parallelepipedal portion is the first sidewall of said block, one of the major surfaces of said second right rectangular parallelepipedal portion is the opposed sidewall of said block, and said second essentially right rectangular parallelepipedal portion extends the given thickness beyond each of the ends of said first essentially right rectangular parallelepipedal portion and each of said wall blocks having opposed sidewalls and stepped ends, and being composed of first and second essentially right rectangular parallelepipedal portions which are integral with one another, and each of which has a given length, the same given width, and the same given thickness as the essentially right rectangular parapiepedal portions of said corner blocks, wherein one of the major surfaces of said first right rectangular parallelepipedal portion is the first sidewall of said wall block, one of the major surfaces of said second right rectangular parallelepipedal portion is the opposed sidewall of said wall block, and said first and second essentially right rectangular parallelepipedal portions of said wall block are offset from each other so that, at both ends of said wall block, one of the two extends beyond the other by an amount which equals the given thickness, one of the stepped ends of a first one of said wall blocks and one of the stepped ends of said corner block nesting so that the first one of said wall blocks and said corner block form a part of a wall which extends in a given direction, and one of the stepped ends of a second one of said wall blocks and the other of the stepped ends of said corner block nesting so that the second one of said wall blocks and said corner block form a part of a wall which extends at 90° to the given direction

9. A building structure as claimed in claim 8 wherein said corner block extends at 90° to the given direction, and which additionally comprises a corner block and two wall blocks constituting a part of an adjacent course of the building structure which is vertically aligned with the structure claimed in claim 8 wherein said additional corner block extends in the given direction.
